(19) United States
(12) Patent Application Publication
(10) Pub. No.: US 2003/0038933 A1
(43) Pub. Date: Feb. 27, 2003

(54) Calibration apparatus, system and method

(75) Inventors: Lyle G. Shirley, Boxborough, MA (US); Gary J. Swanson, Lexington, MA (US); Nathan D. Derr, Cambridge, MA (US)

Correspondence Address: TESTA, HURWITZ & THIBEAULT, LLP, HIGH STREET TOWER, 125 HIGH STREET, BOSTON, MA, 02110, US

(73) Assignee: Dimensional Photonics Inc., Bedford, MA

(21) Appl. No.: 10/126,187

(22) Filed: Apr. 19, 2002

Related U.S. Application Data
(60) Provisional application No. 60/285,457, filed on Apr. 19, 2001.
(60) Provisional application No. 60/327,977, filed on Oct. 9, 2001.

(51) Int. Cl. G01J 1/10

(52) U.S. Cl. 356/243.1

(57) ABSTRACT

An aspect of the invention relates to a calibration standard for a three-dimensional measurement system and various calibration methods and techniques. The calibration standard typically includes a calibration standard surface and a plurality of optical targets. The optical targets being are affixed to the calibration standard surface and define a three-dimensional distribution of optical reference points. The optical targets can be serve as active, passive calibration targets, or combinations of both. In one embodiment, the optical targets include an optical source and a diffusing target, and each of the optical sources are configured to illuminate the respective diffusing target. The optical targets can be removably affixed to the calibration standard surface.

### CROSS-REFERENCE TO RELATED APPLICATIONS

This application claims the benefits of provisional U.S. Patent Application Serial No. 60/285,457 filed on Apr. 19, 2001, and U.S. Patent Application Serial No. 60/327,977 filed on Oct. 9, 2001, the disclosures of which are hereby incorporated herein by reference in their entirety.

### FIELD OF THE INVENTION

The present invention relates generally to the field of imagining technology and, more specifically, to calibration methods and devices for imaging systems.

### BACKGROUND OF THE INVENTION

The process of measuring the characteristics of an object with a detector and transforming the resulting sensor data into a three dimensional representation of the object is of great of interest in the related fields of metrology and photogrammetry. Central to this process of three dimensional measurement and data transformation is the goal of precise and accurate measurement. Accuracy and precision are generally achieved by initially calibrating the system according to a known standard and then recalibrating the system as necessary to minimize errors. Thus, in order for a measurement system to provide reliable and useful data, some manner of calibration is generally required. However, a measurement system made up of a variety of distinct functional elements may require different calibration techniques and devices.

Furthermore the acceptable level of data variation in a given measurement system will dictate the level of calibration required. For example, in some instances optical system parameters such as the extent an optical package is focused or the color quality being achieved in an image can be determined to an acceptable level through simple visual inspection. In other instances where the parameters of the measurement system must be known to precise level, the measurement system must be robustly calibrated through other methods.

When three dimensional objects are imaged, scanned, or measured for the purpose of creating a set of measurement data or an electronic representation of the object, robust calibration methods and devices figure prominently in the process of gathering data of sufficient quality to generate an electronic representation of the object. Calibrating such complex measurement systems often requires calibrating individual system components, such as correcting for lens defects in a camera, in addition to calibrating intersystem component parameters. The spatial location of individual system components, such as a camera or fringe source, in relation to one another is an example of such an intersystem component parameter.

Traditionally the prior art has focused on three dimensional solids positioned in predetermined locations in order to calibrate a three dimensional imaging device or system. These methods have evolved, in part, because of the intuitive appeal of using a three dimensional object to calibrate a three dimensional imaging device. One proposed calibration standard focuses on an array of spheres or hemispheres in a fixed known orientation. The objective of the calibration measurement is to determine the centers of the spheres. Typically, diffuse spheres are preferred because they minimize specular reflections.

One of the difficulties with spherical targets, however, is that it is difficult to measure the center of the sphere accurately without measuring the sphere from both sides. Single-source, single-receiver structured-light systems can at best only measure a hemispherical region of the sphere given a single measurement. Also, because these techniques are based on triangulation, there will always be a portion of the hemisphere viewed by the receiver that is not illuminated by the source. In some situations, the triangulation angle between the source and receiver can be very large, limiting the measurement to as little as half of a hemisphere. Another difficulty with spherical calibration targets is that it is difficult and expensive to manufacture precision spheres. A need therefore exists for calibration devices that can be suitably imaged from multiple angles with definable center regions while not being cost prohibitive to produce.

Another prior-art calibration standard for commercial structured-light measurement systems is a flat plate with circular photogrammetry targets affixed to the plate in a regular array. Often, coded targets are also used so that the measurement system software can automatically locate and identify these targets. A drawback of these flat targets is that they need to be imaged at a number of different orientations, i.e., tips and tilts, in order to provide good calibration results. Previous methods are strongly influenced by photogrammetry methods; the agreement between target locations based on different views provides an indication of the self-consistency of the measurement.

In other aspects of the prior art, many measurement systems employ optical receivers, such as a camera, which introduce depth of field limitations to the calibration process. Thus if a camera is used as part a measurement system, the camera's depth of field will constrain the type of suitable calibration methods. In addition, although certain measurement system components can be factory calibrated, when the different components of the system are assembled in the field there needs to be a way to quickly calibrate the intersystem parameters that is simple, fast, and error tolerant for a field technician to use. Therefore both depth of field independent calibration techniques and simplified field calibration adaptable calibration techniques are important objects for future study in the area of imaging system calibration.

### SUMMARY OF THE INVENTION

The present invention relates to various methods and apparatuses for calibrating three-dimensional imaging systems based on structured light projection. Various aspects of the invention have a general application to many classes of imagining and measurement systems, however the various aspects are particularly well suited to imaging systems utilizing Accordion Fringe Interferometry (AFI).

In one aspect, the invention includes a calibration standard for a three-dimensional measurement system. This calibration standard includes a calibration standard surface and a plurality of optical targets. The optical targets are affixed to the calibration standard surface and define a three-dimensional distribution of optical reference points. The optical targets can serve as active calibration targets, passive calibration targets, or combinations of both. In one embodiment, the optical targets include an optical source and a diffusing target, and each of the optical sources are configured to illuminate the respective diffusing target. The optical targets can be designed so that they are removably affixed to the calibration standard surface. In other embodiments, the optical targets further include an optical target surface. This optical target surface sometimes includes a retroreflective material. A plurality of detectors adapted for measuring the local fringe intensity of a projected fringe pattern can be incorporated into various types of calibrations standards. A detector can be co-located with a respective one of the optical targets in some instances. An active calibration target control system can be incorporated within the calibration standard which acts to independently activate and deactivate each of the plurality of active calibration targets. In some embodiments, the calibration standard surface further comprises a contoured surface chosen to resemble a surface of an object of interest. A light emitting diode can be used as the optical source in various embodiments. In some embodiments, the calibration standard further includes a plurality of supports having a first end and a second end, the first end of each of the supports being affixed to the calibration standard surface, the second end of each of the supports being affixed to a calibration target surface. The optical targets incorporated into the calibration standard can include pyramid targets, each of the pyramid targets having at least three diffuse sides and a vertex, the plurality of vertices being distributed in three dimensions. The calibration standard can also include a wireless module suitable for controlling and/or reading the active calibration targets as well as the target's component elements.

In another aspect, the invention includes an optical calibration target for use in a three-dimensional measurement system which includes a calibration target surface attached to an optical calibration target. In some embodiments, the calibration target support further includes an optical calibration target housing, such that the optical calibration target housing can include at least one of an optical source, and an optical detector, and a diffusing target. In still other embodiments, the calibration target surface includes a retroreflective coating. A fringe intensity detector can be incorporated into the calibration target surface in various embodiments. In some instances, the target can be removably affixed to a geometric locus of interest, such as a hole or edge, on an object being measured by the three dimensional measurement system.

In another aspect, the invention includes a device for positioning an object at a focal point of an optical imaging device adapted for use in three-dimensional measurement system which includes a first movable orienting device fixed relative to an optical imaging device wherein the first movable orienting device has a first projection element, and a second movable orienting device fixed relative to the optical imaging device wherein the second movable orienting device has a second projection element; wherein the first and second projection elements intersect in the vicinity of a focal point of the imaging device when the first and second movable orienting devices are moved in a prescribed manner. In one embodiment the first movable orienting device is a laser beam projector with a first laser beam projection element.

In yet another aspect the invention includes a method for calibrating a measurement system for determining three-dimensional information of an object. According to this aspect initially fringe data is acquired from a calibration object, using the measurement system. The three dimensional calibration object can be precisely measured, in advance of acquiring the fringe data, in order to obtain detailed truth data relating the measurements and spatial interrelation of the components of the calibration standard. Three-dimensional coordinate data for the calibration object is determined in response to the two-dimensional fringe data. Another step of this method is to compare the three-dimensional coordinate data and the three-dimensional truth data for the plurality of locations to generate a deviation measure. One or more calibration parameters in the measurement system are adjusted if the deviation measure is greater than a predetermined value.

In one embodiment, the steps of acquiring, determining and comparing if the deviation measure is greater than the predetermined value can be iteratively repeated. In some embodiments, the calibration parameter being adjusted comprises one of a source head relative position, a source head relative orientation, a camera magnification, projected fringe pattern lens distortion parameters, and camera lens distortion parameters. In other embodiments the method includes the additional step of changing at least one of an orientation or a position of the object by a specified amount. In other embodiments the deviation measure comprises a plurality of difference data. In still other embodiments the deviation measure comprises a statistical measure. The three-dimensional coordinate data for the calibration object is determined at a plurality of locations on the object surface in some embodiments.

In yet another aspect, the invention includes a depth of field independent method for calibrating a measurement system for determining three-dimensional surface information of an object. Initially the method includes the step of providing a plurality of fringe detectors fixed in known spatial relationships. At least one fringe source is provided which projects fringes. The fringes are detected at the plurality of fringe detectors to acquire a fringe data set. Three-dimensional coordinate data is determined for the spatial locations of the fringe source.

In another aspect the invention includes a method for compensating for projection lens imperfections in a fringe projection system. The method includes the step of determining an ideal spherical wavefront output for a projection lens. An actual wavefront output for the projection lens is determined. The ideal spherical wavefront output is compared with the actual wavefront output. A first wavefront error is determined for a first point source. A second wavefront error is determined for a second point source. A fringe phase error is determined from the first and second wavefront errors. The fringe phase error is converted into a correction factor. The correction factor is used to compensate for projection lens imperfections.

In still another aspect, the invention includes a method for compensating for lens imperfections in a fringe projection system. The method includes the step of initially projecting a fringe on a fringe detector. The fringe intensity is measured. A first pixel coordinate (i) and a second pixel coordinate (j) are measured. A three dimensional coordinate is determined from the given fringe intensity, first pixel coordinate, and the second pixel coordinate. A correction factor is determined in order to determine a correction fringe intensity. A corrected three dimensional coordinate is determined based on the correction fringe intensity.

In another aspect the invention includes a method for compensating for lens imperfections in a fringe projection system. A fringe is projected on a fringe detector. A fringe number is measured wherein N is the fringe number. A first pixel coordinate (i) and a second pixel coordinate (j) are determined. A relative coordinate in a pupil plane is determined from the corresponding fringe number. An approximate phase correction map is calculated from the relative coordinates. A correction fringe number is determined. A corrected three dimensional coordinate is determined based on the correction fringe number.

In another aspect, the invention includes a method for compensating for distortion in an optical imaging system. A calibration target with optical grating lines is provided. An optical imaging system including a focal plane array and a plurality of system parameters, wherein the focal plane array further comprises pixels is provided. The optical grating lines of the calibration target are aligned with the pixels of the focal plane array. The calibration target is imaged on a focal plane array of the optical imaging system. Imaging system parameters are changed based on an iterative process to generate a data set. A Moiré pattern is produced from the data set and an image of the calibration target. Distortion coefficients are generated to compensate for distortion in the optical imaging system from the simulated Moiré pattern.

In another aspect the invention includes a method for compensating for distortion in an imaging optical system. A first distortion free pixel coordinate (i), a second distortion free pixel coordinate (j), and a distortion free radius in a sensing array are designated. A distortion center including a first distortion coordinate, a second distortion coordinate, and a distortion radius in a sensing array are designated. A distortion parameter relating the distortion free radius and the distortion radius are designated. A calibration target is imaged to establish the distortion parameter. The value of the distortion parameter is minimized. A calibration target is imaged to establish the distortion parameter. The distortion parameter is used to minimize a distortion error in an imaging measurement.

In another aspect, the invention includes a method for appending a plurality of related three-dimensional images of an object of interest, each of the three-dimensional images having a unique orientation with respect to a three-dimensional measurement system. An orientation pattern is projected at a fixed position on the object of interest. A first three-dimensional measurement of the object is acquired with the three-dimensional measurement system being at a first position relative to the object of interest. The three-dimensional measurement system is moved to a second position relative to the object of interest. A second three-dimensional measurement of the object is acquired with, the orientation pattern being at the fixed position on the object and the three-dimensional measurement system being at a second position relative to the object. In one embodiment, the orientation pattern comprises a plurality of laser spots or other suitable projected optical pattern.

### BRIEF DESCRIPTION OF THE DRAWINGS

The invention is pointed out with particularity in the appended claims. The advantages of the invention described above, together with further advantages, may be better understood by referring to the following description taken in conjunction with the accompanying drawings. In the drawings, like reference characters generally refer to the same parts throughout the different views. The drawings are not necessarily to scale, emphasis instead generally being placed upon illustrating the principles of the invention.

FIGS. 1A-1C are schematic cross-sectional views depicting various passive calibration targets according to different illustrative embodiments of the invention;

FIGS. 2A-2C are schematic cross-sectional views depicting various active calibration targets according to different illustrative embodiments of the invention;

FIGS. 3A-3D are schematic diagrams depicting a top plan view of various calibration targets according to some illustrative embodiments of the invention;

FIG. 3E is a perspective view of another embodiment of a calibration target according to an illustrative embodiment of the invention;

FIG. 4 is a schematic diagram depicting a calibration standard incorporating a plurality of calibration targets and various elements of an imaging system according to an illustrative embodiment of the invention;

FIG. 5 is a schematic diagram depicting a calibration standard incorporating a plurality of calibration targets according to an illustrative embodiment of the invention;

FIG. 6 is a schematic diagram depicting a calibration standard incorporating a plurality of calibration targets according to an illustrative embodiment of the invention;

FIG. 7 is a schematic diagram depicting a method of using a calibration target in concert with an object of interest according to an illustrative embodiment of the invention;

FIG. 8 is a schematic diagram depicting a method of using a calibration standard incorporating a plurality of calibration targets for determining the spatial location of fringe sources independent of depth of field according to an illustrative embodiment of the invention;

FIG. 9 is a schematic diagram depicting an apparatus and method for actively stitching together resultant imaging data from an object of interest according to an illustrative embodiment of the invention;

FIG. 10 is a block diagram illustrating a method for measuring a lens in an optical receiver for distortion and reducing the effects of lens distortion in an imaging system according to an illustrative embodiment of the invention;

FIG. 11 is a Moiré pattern image of a first measurement of a calibration target according to an illustrative embodiment of the invention;

FIG. 12 is a Moiré pattern image of a second measurement of a calibration target according to an illustrative embodiment of the invention according to an illustrative embodiment of the invention;

FIG. 13 is a simulated image of the first measurement image in FIG. 11 according to an illustrative embodiment of the invention;

FIG. 14 is a simulated image of the second measurement image in FIG. 12 according to an illustrative embodiment of the invention;

FIG. 15 is a schematic block diagram of various components of an AFI system according to an illustrative embodiment of the invention;

FIG. 16 is a graph of the aberration of a projection lens according to an illustrative embodiment of the invention;

FIG. 17 is a graph of the fringe phase error that results from aberrations in a projection lens according to an illustrative embodiment of the invention;

FIG. 18 is a graph of a phase error correction map according to an illustrative embodiment of the invention;

FIG. 19 is a graph of a the residual phase error after correction by a projection lens distortion reduction method according to an illustrative embodiment of the invention;

FIG. 20 is the coordinate system typically used for calibrating a single fringe projector single camera AFI system according to an illustrative embodiment of the invention;

FIG. 21 is the master equation relating ideal pixel locations (i) and (j) and ideal fringe number N to three-dimensional coordinates x, y, and z for a single fringe projector single camera AFI system according to an illustrative embodiment of the invention;

FIG. 22 is the measurement model that transforms measured values of pixel locations (i) and (j) and fringe number N to three-dimensional coordinates x, y, and z according to an illustrative embodiment of the invention;

FIG. 23 is a diagram showing the reverse transformation equations corresponding to FIG. 22 suitable for use in various calibration methods according to an illustrative embodiment of the invention; and

FIG. 24 is a diagram showing an interference fringe based apparatus and method for actively stitching together resultant imaging data from an object of interest according to an illustrative embodiment of the invention.

### DESCRIPTION OF THE PREFERRED EMBODIMENTS

Embodiments of the present invention are described below. It is, however, expressly noted that the present invention is not limited to these embodiments, but rather the intention is that modifications that are apparent to the person skilled in the art and equivalents thereof are also included.

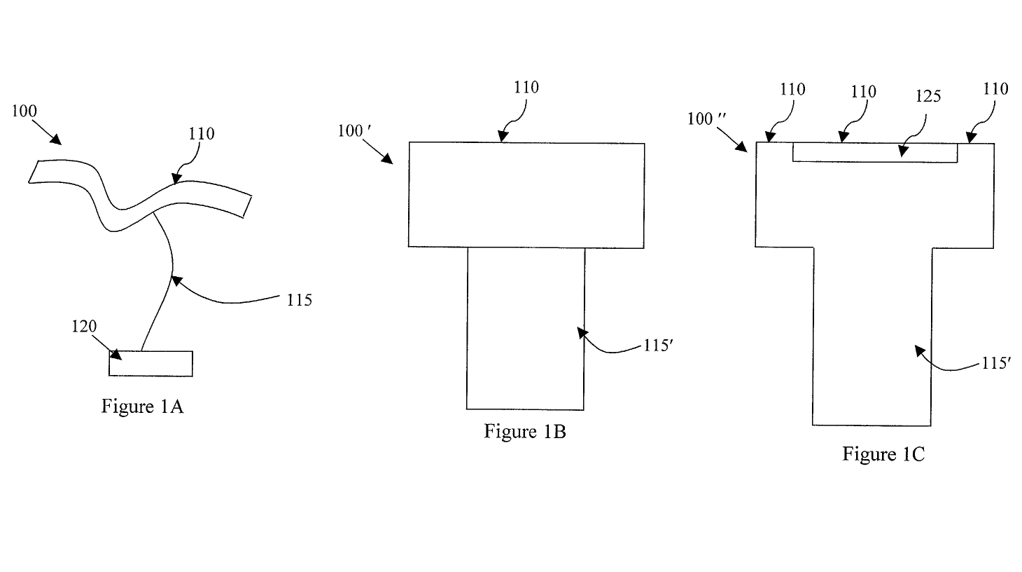

Referring to FIGS. 1A-1C, various passive calibration targets 100, 100′, 100″ (generally 100) constructed in accord with different illustrative embodiments are shown. These calibration targets are characterized as passive as they do not include any electrically powered components. Furthermore, these are passive embodiments in the sense that they relate positional coordinate information when illuminated by passively reflecting light suitable for detection by an optical sensor such as a camera rather than actively transmitting light from an internal optical source. FIG. 1A shows a calibration target which includes a calibration target surface 110, connected to a support 115, which is in turn connected to a base 120. In some embodiments the support 115′ can also serve as the base. Configurations in which the base has been subsumed into the support are shown in FIGS. 1B and 1C. The calibration target surface 110 can be contoured or substantially planar. In various preferred embodiments the calibration target surface 110 includes retroreflective materials. Thus if a retroreflective material coating has been incorporated into the calibration target surface 110, when the coating is illuminated a reflected spot can be detected by a sensing system. The retroreflective material can be incorporated throughout the calibration target surface 110 or in localized regions. The presence of localized regions facilitates forming two dimensional retroreflective material patterns on a given passive calibration target surface 110.

FIG. 1C shows a passive calibration target 100″ with a portion of the calibration target surface 110 having a localized region 125. The localized region 125 is a portion of the general calibration surface 110 in this embodiment. Although shown as located in the center of the surface 110, the localized region 125 can occupy any position on the calibration target surface 110. The region 125 can include retroreflective materials or other suitable materials with optically responsive properties. The shape and material composition of the localized regions 125 can be chosen to facilitate determining the center of the calibration target by an optical system such as an interference fringe projector or an accordion fringe interference (AFI) based measurement system. These geometric and material characteristics can be used in conjunction with conventional photogrammetry centroiding and interpolation algorithms to ascertain the center point of a given passive calibration target 100 when imaged and illuminated as part of a calibration method.

In one embodiment, the passive calibration target 100 is made of a uniform material. Various embodiments of the passive calibration targets 100 can be hollow, solid, or combinations thereof with hollow and solid constituent regions. The calibration targets can contain specific hollow regions which serve as a housing for other calibration system elements. In one embodiment, the calibration target surface 110 has a circular boundary when viewed normal to the center of the surface 110.

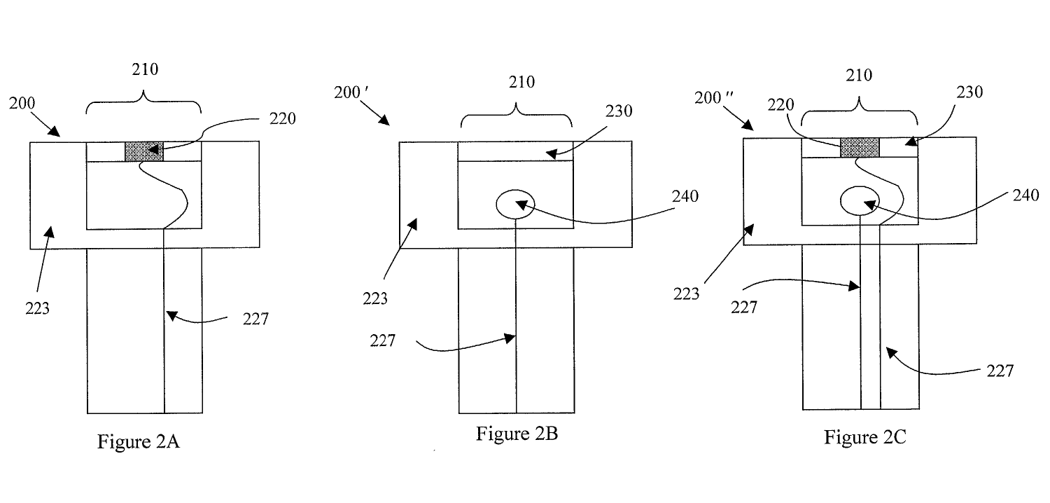

Referring to FIGS. 2A-2C, various active calibration targets 200 in accord with different illustrative embodiments are shown. Any calibration target which includes optical, electrical or mechanical components in lieu of or in addition to an optically responsive surface as a feature of the calibration target is classified as active calibration target 200, 200′, 200″ (generally 200). The distinction between active and passive targets is not a limitation, but simply for logical organization. The various types of active calibration targets and passive calibration targets form a group of optical targets suitable for incorporation into various aspects of the invention.

Active calibration targets 200 generally have a calibration surface which can be contoured or substantially planar. The region of the calibration target through which the functional components of an active calibration target interact with a given measurement system is an active spot (generally 210). The active spot 210 is generally a portion of the calibration target surface. In other embodiments, the active spot can range over the entire calibration target surface. The active spot 210 in some embodiments includes the region below the calibration target surface where electric or mechanical components have been incorporated within the calibration target.

In various embodiments, an active calibration target 200 includes a detector 220 disposed within the active spot 210 as shown in FIGS. 2A and 2C. A calibration target housing 223 is used in some embodiments to contain the functional elements of the active calibration target 200. The housing 223 can comprise any suitable shape. The power and control wiring 227 for a given active calibration target component can be disposed within a hollow core in some embodiments as shown. In one embodiment the detector 220 is adapted for measuring the local fringe intensity of a projected fringe pattern; however other suitable detector types can also be used. A given active calibration target 200 can include an optical detector, an optical transmission source, and a diffusion material to receive the light from the transmission source.

In FIG. 2B an active calibration target 200 which includes an optical source 240 and a diffusing target 230 is shown. The optical source 240 incorporated into the active calibration target 200 is generally configured to illuminate an aligned associated diffusing target 230. In one embodiment, these elements are oriented to transmit diffuse light through the active spot 210. The diffusing target 230 and the optical source 240 are disposed within a cavity 223 in this embodiment. In other embodiments the cavity is filled with a solid transparent material to preserve the orientation of the functional components of the active calibration target 200. The optical source 240 in various embodiments is a source of coherent light like a laser diode, a non-coherent light source like a LED, a pattern projector or any other light source. Many of these active target elements can be combined as shown in FIG. 2C which illustrates an active target 200″ embodiment which combines a detector, 220, an annular diffusion target 230, and an optical source 240.

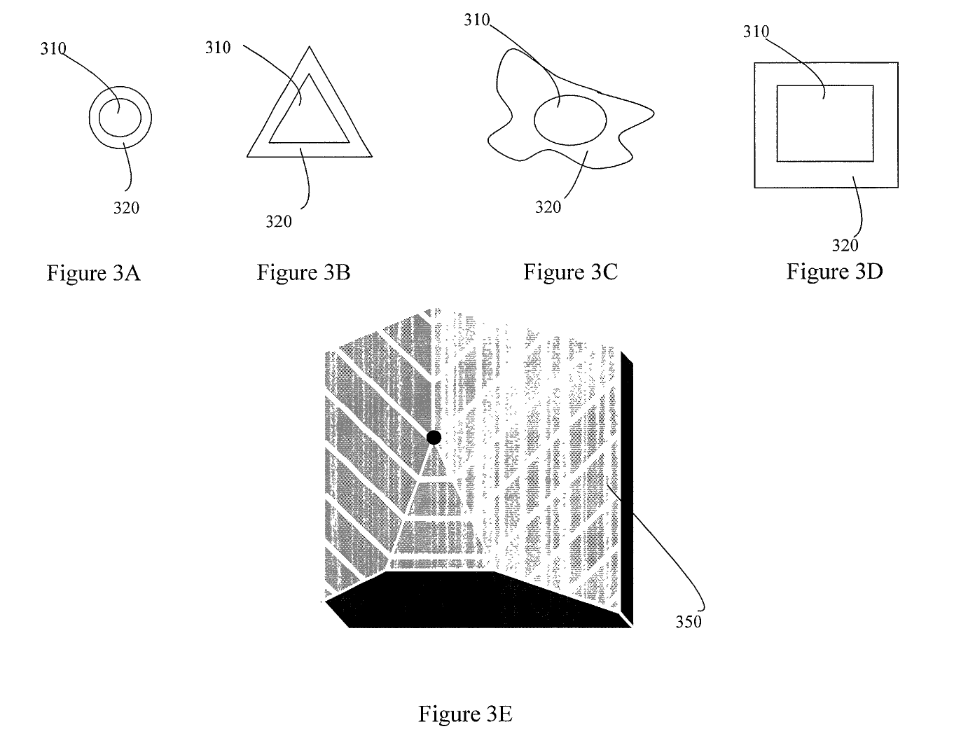

FIGS. 3A-3D show a plan top view of various calibration target embodiments. These figures further emphasize the concept of a calibration target functioning as a two dimensional calibration element that can be suspended in a known spatial orientation. In various preferred embodiments the surface of the calibration target will comprise a defined center and be symmetric. The general top views of FIGS. 3A-3D are shown with an active portion 310 which corresponds to the active region 210 in the active calibration target 200 or a localized region 125 in a passive target 100 described in FIGS. 1C and 2A-2C respectively. The active portion 310 is a subset of the calibration target surface 320. This active portion 310 can be substantially planar or contoured in various embodiments. The four illustrative embodiments shown in FIGS. 3A-3D are general configurations, the two dimensional surface of a calibration target can be drawn from the class of all possible suitable geometric shapes or contoured boundaries.

Referring to FIG. 3E, a pyramidal shaped passive calibration target 350 is illustrated from a top perspective view. This pyramid shaped calibration target 350 has three faces which intersect at a central vertex. This intersection can be used to ascertain the center of the target 350 in various embodiments. A high level of calibration precision can be obtained through the use of a large pyramid as a passive calibration target. Various pyramidal solids with a plurality of faces intersecting at a common vertex can be used as both active and passive calibration targets in various embodiments. It is desirable to make the surface slope of the pyramid faces small enough to minimize any shadowing on the calibration target's faces.

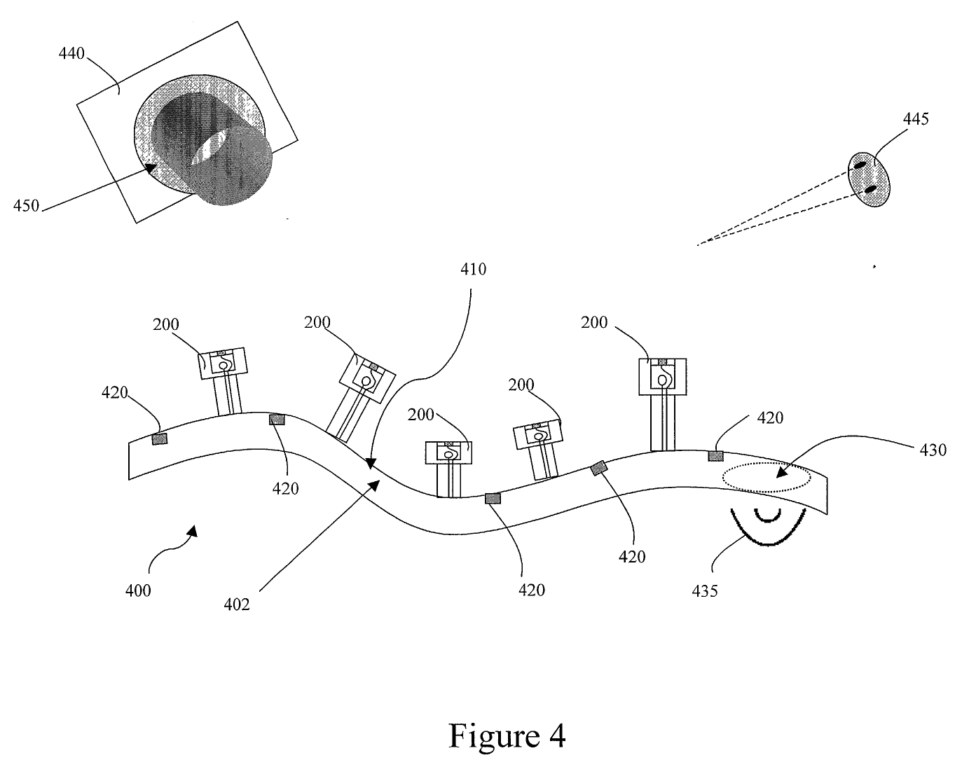

FIG. 4 shows a calibration standard 400 comprised of plurality of active calibration targets 200 disposed on a calibration plate 402. Although not shown in the illustration, passive calibration targets 100 could be used in lieu of the active calibration targets 100 or interspersed between the active calibration targets on the calibration standard 400 in the current embodiment. The calibration standard 400 has a calibration standard structure 410 upon which one or more calibration targets 200 can be disposed. In various embodiments, the calibration standard structure 410 can be the surface of an object. Preferably the calibration standard 400 is a rigid object in order to minimize the impact of vibrations and orientation shifts on the disposed calibration targets 200. The calibration standard 400 can further include detectors 420 directly incorporated in the calibration standard structure 410 as shown. A camera 440 and an interference fringe projector 445 are also shown as components of an illustrative imaging system suitable for use with the calibration standard 400. Preferably the detectors 420 are suitable for measuring the local fringe intensity of a projected fringe pattern; however other suitable detector types can also be used. Motion sensors can also be incorporated into the calibration standard 400 to detect changes in the standard's position once a given measurement system has been calibrated.

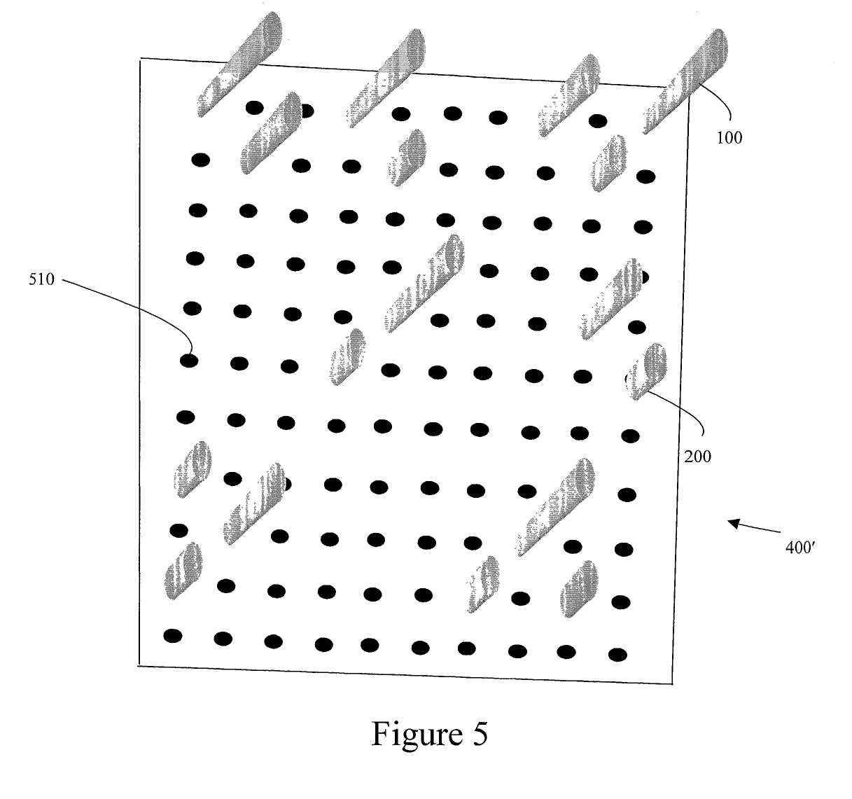

The calibration targets 200 disposed on the structure 410 can be fabricated as part of the calibration standard 400 in some embodiments. Therefore in one aspect a calibration standard can comprise a calibration standard structure 410 and a plurality of calibration targets 100, 200. In other embodiments the calibration targets 100, 200 are detachable from the calibration standard 400 and capable of being oriented and fixed anywhere on the structure 410. This aspect of the invention which relates to positioning and detachability of the calibration targets is shown in FIG. 5.

Still referring to FIG. 5 the illustrative calibration standard 400 embodiment is shown as comprising a grid of calibration target fixation points 510. The fixation points 510 can include any suitable means for either temporarily or permanently fixing an active or passive calibration target 100, 200 to the calibration standard 400. The calibration targets 100, 200 include an attachment portion designed to facilitate adhesion to the calibration standard at a fixation point 510. Fixation of the calibration target 100, 200 to the calibration standard 400, in one embodiment is achieved by a complementary machined threads at the fixation points 510 and on the targets 100 themselves, snap in connectors, magnetic connectors, or other suitable fixation means.

Referring back to FIG. 4, the calibration standard 400 can be any suitable two or three dimensional shape, in addition to being hollow, solid or combinations thereof. The shape of the calibration standard 400 can be chosen in anticipation of the general shape of the object that will be the subject of the measurement system being calibrated. In some preferred embodiments, the shape of the calibration standard 400 is chosen to reflect some of the geometric contours of the object of interest being imaged or measured. Thus if an airplane wing with a concave contour was the object of interest a calibration standard 400 with a concave contour and a plurality of active calibration targets, passive targets, individualized fringe detectors or combinations thereof can be disposed upon the surface of the calibration standard 400.

An optional wireless module 430 can also be incorporated into the calibration standard as shown. The wireless module 430 can add different features to the calibration standard 400. In one embodiment the wireless module is an IR Ethernet computer link. The module 430 can wirelessly relay output data from the detectors disposed within some of the active calibration targets 200 through an electromagnetic signal 435. In addition, input control data can be sent to the calibration standard to active and selectively operate the optical transmission sources contained within various active calibration targets. Furthermore, having control over the sources, for example, may simplify sorting out which source corresponds to which pixel location. The calibration standard 400 can further include one or more processor modules suitable for processing data and/or controlling the inputs and outputs of the active calibration targets 200 disposed upon the calibration standard. In some embodiments the calibration targets disposed on the surface of the calibration standard can be arranged in localized clusters The calibration standard 400 with calibration targets disposed upon its surface 410 of the invention is particularly suitable for calibrating any accordion fringe interference (AFI) projection based system.

Still referring to FIG. 4, one calibration method of the invention is illustrated. The calibration targets 100, 200 are shown as being distributed over a rigid contoured calibration standard 400. In one preferred embodiment, the calibration target surfaces are flat and parallel, but offset spatially in three dimensions. The individual calibration targets 100, 200 are positioned with varying heights and lateral positions. After target placement, the positions of the calibration targets 100, 200 can be initially determined, for example, by using a coordinate measurement machine (CMM), laser tracker, photogrammetry system, or a calibrated AFI system to probe the calibration targets 100, 200 and ascertain their spatial position. This process of determining the location of the calibration targets results in the creation of data set called truth measurements. A measurement system, such as an accordion fringe interferometry based system, can be used to image the calibration standard and the associated calibration targets. The results of the measurement system can be contrasted with the set of truth measurements.

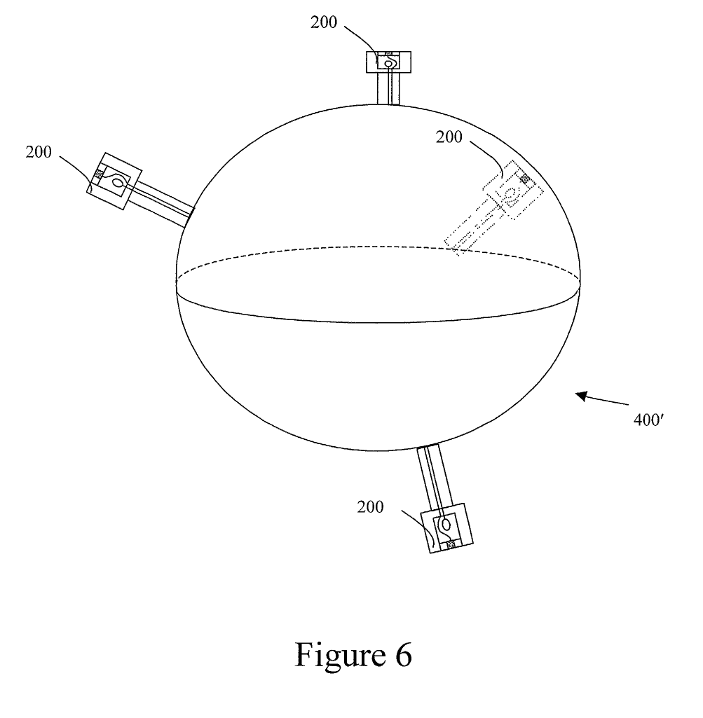

Various three dimensional shapes can be used as a calibration standard with active and passive calibration targets disposed thereon. A substantially spherical calibration standard 400′ is shown in FIG. 6. In this embodiment the calibration standard 400′ is shown as a substantially spherical three dimensional shell or solid. Thus if a series of spherical components where going to be measured or imaged by a measurement system, this calibration standard 400′ and associated calibration targets 200 would be a good choice to calibrate the measurement system. The targets may be generally disposed orthogonal to the surface of calibration standard component in some embodiments. In other embodiments, the targets may be disposed on the calibration standard with a non-orthogonal orientation. The various calibration standards 400′ can be concave, convex, substantially planar, or any other suitable contour or three dimensional shape in various embodiments.

To the extent that the results of the measurement or imaging system disagree with the truth measurement, the measurement imaging system parameters are modified and the calibration parameters are adjusted. The parameters can be adjusted iteratively in order to obtain a suitable level of agreement between the truth measurement and the data acquired by the measurement system in various embodiments. This process is iteratively performed until the truth data and the measurement data converge to a predetermined acceptable level for a given measurement application. Furthermore, in one embodiment in the context of calibrating a measurement system based upon the projection of interference fringes, the detectors 420 incorporated within some calibration standard 400 embodiments are used to provide a supplemental data set to calibrate the measurement system. The calibration standard 400 can also be moved in known repeatable patterns while being imaged to facilitate additional calibration data. This motion of the calibration standard 400 and associated calibration targets can be facilitated by incorporating actuators or a motorized assembly within or attached to the calibration standard 400 in various embodiments.

In one embodiment, a calibration standard including a metal calibration plate, and 28 retroreflective calibration targets mounted at various heights above the calibration plate similar to the embodiment shown in FIG. 4 was used to calibrate an AFI system. The position of the targets was determined with a CMM by probing the sides and tops of the targets. The calibration procedure was carried out as described above. An RMS agreement of better than 0.0005″ was achieved over this 18″ by 18″ area. A large component of this error is believed to be from inaccuracies in the CMM measurement. A calibration on a smaller 6″ by 6″ calibration standard yielded a similar agreement of better than 0.0005″.

In use, the positions of the calibration targets 200 are initially determined by using a CMM or other device to probe the calibration targets in order to determine their spatial orientation and position. Typically, the next step is to determine the pixel location, or i,j, values of each calibration target surface. The i and j coordinates correspond to coordinates defined in the pixel space of the optical detector system such as the pixel array in digital camera. In one aspect of the invention, it is advantageous to use a light in the vicinity of the camera to illuminate the calibration standard. This helps achieve a maximum return of reflected light from the retroreflective coating on the calibration targets. In order to minimize any angular dependence of the illumination, the source of illumination may be a ring light 450 that surrounds the camera lens. If the fringe source is spectrally narrow, then to minimize chromatic effects or the effects of varying focus that depend on wavelength, the light may be a ring of LEDs that emits at substantially the same wavelength as the fringe source.

Alternatively, an optical notch filter may be placed on the camera lens. This filter passes the spectral component corresponding to the fringe source. In addition, the fringe pattern from the source head may be switched off during the exposure to eliminate interference. The camera will record the reflected spots which correspond to the imaging systems measurement of where the calibration target 100 is located. The centroids of the reflected spots may be determined through one of many algorithms known to one of ordinary skill in the art.

In other embodiments, the optical source for illuminating the targets need not be spectrally narrow and need not be placed in the vicinity of the camera lens. The targets need not be retroreflective. A fringe source can also be used as the illumination source to determine the pixel location. To minimize the effects of the intensity variations due to the fringe pattern, fringe intensities could be added at different phase shifts, or one of the two sources generating the fringe pattern could be blocked. If the fringe source is substantially coherent, speckle will partially degrade the determination of centroids. If the fringe source is broadband, speckle is eliminated.

The next part of the calibration process is to determine the fringe number N at the centroid position of each of the calibration target surfaces. A centroid generally refers to the point located within a polygon or other geometric boundary which coincides with the center of mass of a uniform sheet having the same shape as the corresponding polygon or geometric boundary. This may be done to high precision by fitting the fringe value N across the calibration target surface to a smooth function of pixel values i and j, and sampling this function at precise (including fractional pixel) values of i and j determined by the centroiding done in conjunction with illuminating the passive calibration targets 100. This procedure yields high-precision values of the i, j, and N locations of the centroid of each active spot 210.

Another calibration approach based on using principally active calibration targets can be understood by referring again to FIG. 4. As was previously discussed in the introduction of FIG. 4, the individual active calibration targets 200 incorporate a source 240 and a receiver 220. The source 240, such as a LED, back illuminates a diffusing disk 230. The diffusing disk 230 produces a uniform light distribution over the disk 230 that is observed by the camera for centroiding purposes. A small detector 220 may be placed in the center of the diffusing disk 230, for example, to measure the fringe pattern intensity falling on the target. This fringe pattern originates from one or more fringe sources 445. This fringe source is generally a component of an accordion fringe interferometry based measurement system.

Any non-uniformity caused by the small detector 220 will not affect the centroiding result if the detector is centered or if a centroiding algorithm is used that emphasizes the outer edge of the active spot 210. The sources need not be circular. Other geometric shapes and structured targets, such as rings, can be used as was shown in FIGS. 3A-3D. In another embodiment, the sources and receivers of the active calibration targets are not collocated. It is only necessary to know the positions of these elements to construct a calibration standard. Using a detector in this manner to measure the fringe pattern improves the accuracy of the fringe value measurement N by eliminating the speckle effects that are present in situations where coherent light is detected that has been scattered by a diffuse surface.

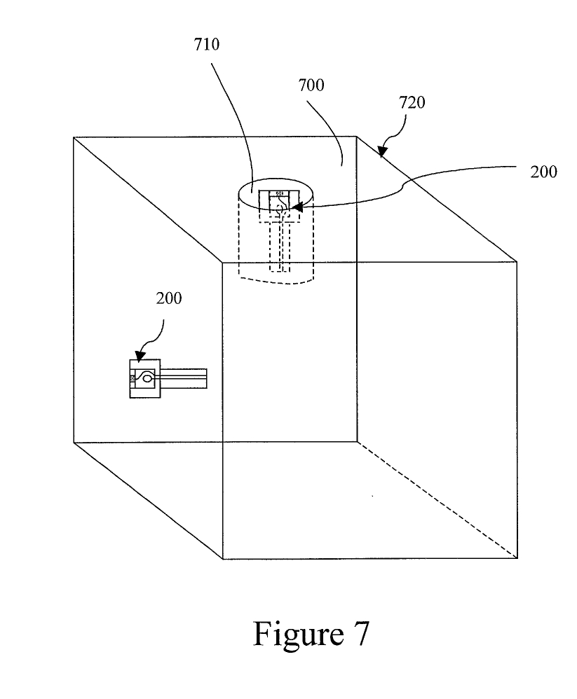

Referring to FIG. 7, an aspect of the invention relating to improving the calibration and imaging of certain classes of objects of interest is illustrated. An object of interest is one for which a three dimensional image or set of measurement data is desired. In this illustrative embodiment, a general object of interest 700 is shown as a rectilinear three dimensional solid. This particular object has a hole 710 and a series of sharp edges 720. Calibration targets can be placed in a select geometric locus on or within the object 700.

It is often desirable to precisely determine the location of a feature of a part such as a hole 710 or edge 720 or to have a fiducial indicator from which to compare and align various measurements. Hole 710 locations, for example, can be precisely determined by inserting calibration targets 100, 200 into the holes. Edges 720 can be determined by placing one or more of these calibration targets 100, 200 against the geometric locus of the edge being measured. Fiducial indicators can be attached to the object of interest or attached to a structure surrounding the object of interest. It is particularly convenient to have a set of calibration targets 100, 200 permanently or semi-permanently located around the perimeter of a measurement area. One advantage of this arrangement is that it allows continuous monitoring of calibration and serves as a data quality check.

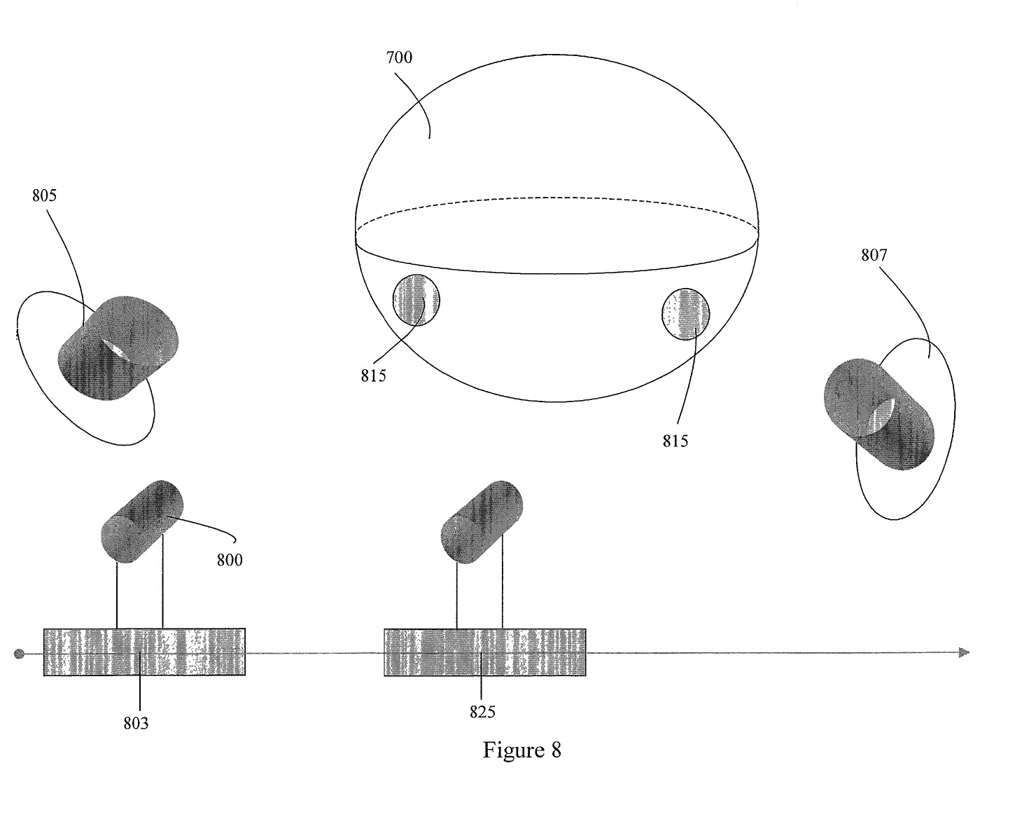

In various measurement and imaging systems, it is desirable to image a three dimensional object from multiple angles in order create a three dimensional representation of that object or a set of reliable measurement data. If multiple views of an object are imagined it can be difficult to ascertain where one view intersects with another view to provide a representation of the object's surface. In the past, attempts to actively stitch together different object views have required placing physical targets directly on the surface of the object of interest. In many applications it is not desirable or possible to have direct contact with an object. Referring to FIG. 8 a schematic representation of an active stitching apparatus is shown that does not require any contact with the object of interest 700. In this illustrative embodiment the object of interest 700 is a substantially spherical three dimensional object.

Referring to FIG. 8, a light source 800 is illustrated at a first projection position 803. A first receiver 805 and a second receiver 807 are also shown in this illustrative embodiment, but more receivers can be incorporated in other embodiments. Typically these receivers are cameras. The light source 800 initially projects an active marker 815 such as a pattern, e.g., laser spot, interference fringes, concentric circles or other suitable light pattern onto one or more locations on the surface of the object being measured when at its first projection position. The pattern of the active marker 815 can then be used to match up different 3D images taken at different camera locations. This aspect of the invention allows physical markers such as stickers on the surface of the object to be done away with in many imaging systems. In the alternative, the light source can be moved to a second projection position 825 at a later time and the receiver can image the object of interest at that time while using the different active markers 815 to stitch together a representation of the objects surface.

In one specific illustrative method for achieving this, initially a first 3D image is measured, then an active marker is projected at three locations on the object with the 3D imaging source turned off. The camera used to make the first 3D image measures the object while illuminated by the active markers and with no changes to the camera location. The pixel locations of the active markers are then determined to sub-pixel precision by processing. This processing can take many forms, for example, determining a centroid of laser spots or other projected structured light patterns.

The active markers 815 are projected by one or more fixed light source projectors that are mechanically independent from the AFI measurement system. This allows the active markers 815, which are projected on the surface of the object of interest, to be kept stationary while the AFI system moves to a new location. In various embodiments, the only component of the AFI measurement system which moves is the optical receiver, which is typically a camera. In other embodiments the entire AFI measurement system might be in a housing mounted on a track designed to facilitate motion about the object of interest while maintaining calibration. Measurements are then taken by the optical receiver of the AFI system which records the fringes projected by the source head and the active markers 815 projected by a light source. The active markers should be common to all of the AFI measurements which are taken and provide a means of lining up common components of the surface in the 3D data. Active and non-active targets can also serve as references for stitching together different views of an object. In fact, active calibration targets can be placed in different orientations so that front and back views of the object of interest, for example, can be combined.

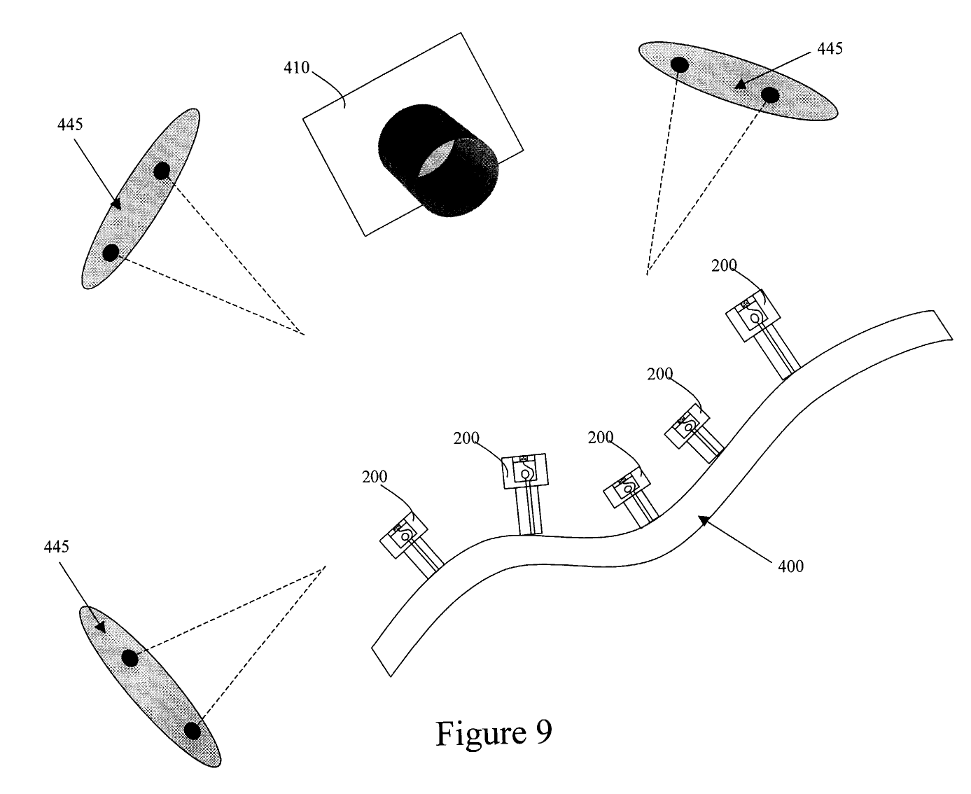

Referring to FIG. 9 a depth of field independent apparatus for calibrating a measurement system is shown. In various preferred embodiments this method can be utilized in an interference fringe projection based imaging system. As a result of using active calibration targets 200 which include a fringe intensity detector, the fringe number N can be determined outside of the camera depth of field. This follows because sufficient fringe intensity detectors can be used to mathematically extrapolate the position of the fringe sources from the data obtained at the detectors. This mathematical determination of source position is camera independent. One advantage of this depth of field independence is that when Accordion Fringe Interferometry is implemented with multiple sources, the camera location can be removed from the calibration measurement process, i.e., the camera can be placed arbitrarily. The detectors 420 in the active calibration targets can then be used to determine the relative positions and orientations of all of the source heads without a need for imaging or seeing the whole scene with a camera.

Therefore if a constellation of fringe sources is arranged in a fixed orientation, a three dimensional calibration standard with active calibration targets disposed in a known or reference orientation can be used to determine the unknown locations of the fringe sources relative to the calibration standard. The positions of the active calibration targets can be ascertained in advance through, for example, a coordinate measuring machine (CMM) as has been explored in other calibration method embodiments. This serves as truth measurement. The CMM can provide a known orientation for the calibration standard and plates which can in turn be used to calibrate an imaging system. The fringe sources will project fringes on the active calibration targets. Given a sufficient number of active targets the mathematical degrees of freedom for fringe source location will diminish as a data set of active target fringe intensity data is built up. This process can be facilitated by sequentially turning on and off different fringe sources to establish different data sets. These various data sets can be mathematically transformed to generated spatial locations for the sources based on equations known in the art.

Another aspect of the invention relates to simplifying the process of setting up an imaging system in the field. In practice, the parameters representing the camera lens and fringe distortions can be factory calibrated. Field calibration, or system setup, then may consist primarily of determining the relative position and orientation of the source with respect to the receiver. In one configuration, the source and receiver are on separate tripods or fixtures that can be placed at will to optimize the measurement. The objective of field calibration is then to determine the relative positions and orientations of these two components in a rapid manner that is convenient and simple for the operator to implement.

In another configuration, the source and receiver are on a fixed baseline. Field calibration can be implemented periodically to check performance or to adjust to changes due to the environment such as thermal expansions. The fixed-baseline system can, for example, be moved into different positions to obtain a more complete measurement of a complex object without requiring recalibration. Field calibration also makes it easy to optimize the fixed-baseline system for different measurements by varying the baseline length and pointing directions of the source and receiver on the fixed structure.

In the above approaches, there are various ways of handling the lens magnification, which in a simple lens is related to the focus setting of the lens. For example, the lens magnification can be preset, it can be tied to the focus setting of the lens, or it can be included in the calibration. If the focus is preset, one convenient approach is to have two laser pointers, beam projectors, pattern projectors, strings, wires, or other optical beams or mechanical equivalents which intersect at the optimal focal plane in object space. This allows an object to be easily set at the optimal distance from the imaging system or for a fixed baseline system to be easily set at the optimal distance for a given viewing geometry.

The process of calibration often requires recognizing certain error types, modeling their affect on a measurement system, and developing schemes for compensating the errors in order to enhance data quality. Previously, various methods and structures relating to the calibration of various imaging and measurement systems have been discussed. In particular many of these have been directed to calibrating the position of an interference fringe source, or the position of an optical receiver such as a camera. Distortion and aberration effects in lenses present another issue that must be resolved to ensure the proper functioning of a measurement system. In the realm of AFI based systems, lenses are present in the optical receiver and in some instances lenses serve as a projection element in the interference sources. The general case of measuring and compensating for lens distortion in an optical receiver will next be explored as another aspect of the invention prior to considering lenses in the context of fringe projection.

It is often practical to incorporate an off the shelf optical device into the design of an innovative measurement system. If a proprietary camera system is to be incorporated into a developing measurement system, it may be necessary to measure the properties of the lens system if the information is not forthcoming from the supplier in order to best integrate the lens into the larger system. In one aspect the invention provides a method for measuring the properties of lens disposed in a camera by using a grating target, the properties of known Moiré patterns, and the parameters associated with various simulated Moiré patterns. Similarly, the invention also provides a method for reducing lens distortion once a given lens has been measured and evaluated for error.

In one illustrative embodiment, a lens distortion reduction method was developed with a Nikon AF Nikkor 50 mm focal length lens with F/1.8 (Nikon Americas Inc., Melville, N.Y.). This lens was used in a Thomson Camelia (2325 Orchard Parkway, San Jose, Calif. 95131) camera with a TH7899 focal plane array, 2048×2048 pixels, and a 14.0×14.0 μm pixel size. A grating based calibration plate was used from Advanced Reproductions (Advanced Reproductions Inc., North Andover, Mass.). In one embodiment, the grating based calibration plate had the following characteristics: a 635.7 mm×622.0 mm total area, 300 μm wide grating lines, a 300 μm spacing between the grating lines, and it included a photographic emulsion on acetate substrate mounted on a 25×26 inches glass plate (¼ inch thick).

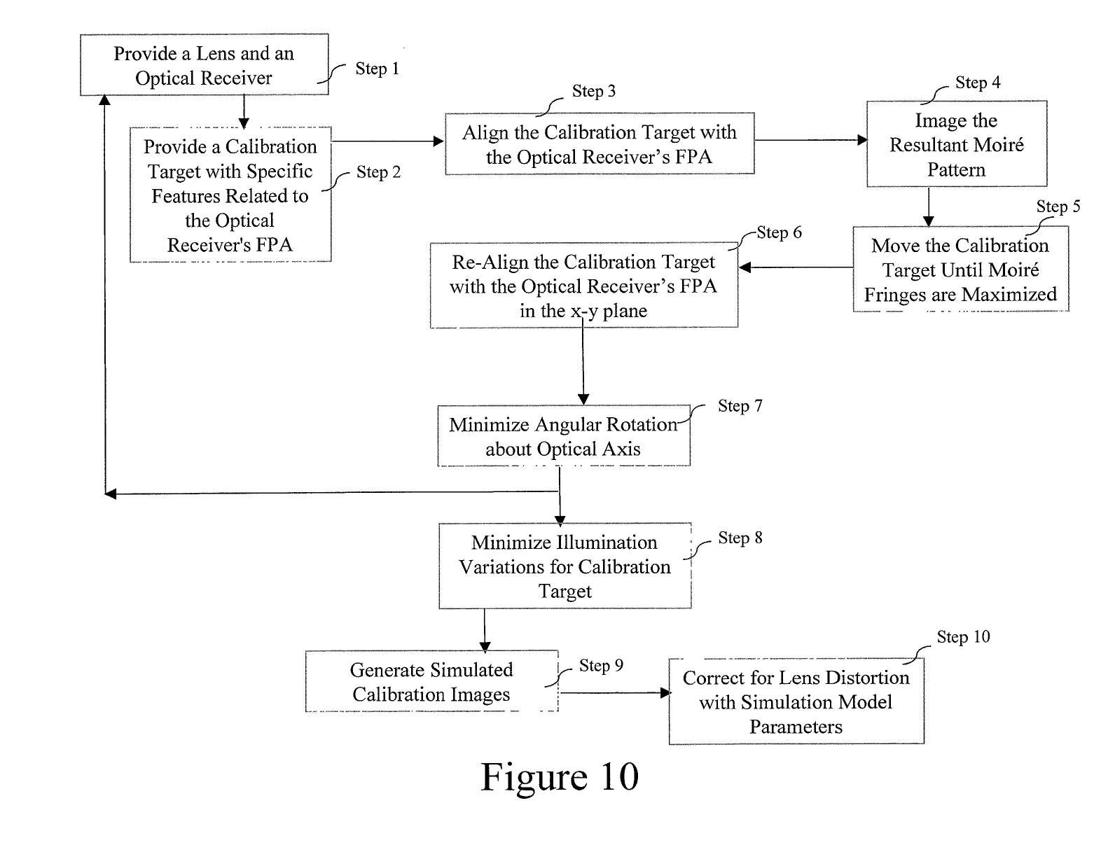

Referring to FIG. 10, as part of a method for measuring a lens for distortion and calibrating for distortion errors, initially a camera is provided (Step 1) containing the lens of interest. In one embodiment, the lens used is a standard Nikon SLR camera lens. This lens is suitable for use in an optical receiver as part of a larger AFI system. In order to use this lens, it is beneficial to quantitatively describe the distortion of the lens. The measured lens distortion will be used in the calibration of the AFI system.

The procedure to measure the lens distortion is to image a calibration target with specific characteristics onto the camera's focal plane array (FPA). A grating based calibration target has periodic features that, when imaged onto the FPA, correspond to the size of a pixel in the FPA. Therefore a suitable calibration target is provided (Step 2) as a step in the calibration method. A Moiré pattern is an independent pattern seen when two geometrically regular patterns, are superimposed. The calibration target is chosen to possess a periodic nature that will produce a Moiré pattern when imaged on the FPA. The periodic nature of the calibration target interacts with the periodic structure of the FPA. This results in the formation of specific Moiré pattern which can be imaged by the optical receiver. The resulting Moiré pattern contains information that is correlated with the distorted image of the calibration target. Since the characteristics of the calibration target, such as the periodicity of a grating, are known, the distortion from the lens can be mathematically extracted. This yields a measurement for the amount of distortion present in a given lens of interest.

The specific characteristics of the calibration target are important to determining the amount of lens distortion because they serve as the known variables that will facilitate the mathematical determination of the lens distortion. In one embodiment, the calibration target included a linear binary amplitude grating with a 50% duty-cycle. The number of grating periods, in this embodiment, across the calibration target was equal to ½ the number of pixels across the focal plane array. The Thomson FPA has 2048 pixels per linear dimension, so the calibration target has 1000 grating periods. The calibration target is designed to have 1060 grating periods in order to slightly overfill the focal plane array. The width of each grating line on the calibration target is 300 μm. A magnification of approximately 21.42 is required in order to image each grating line to the width of a FPA pixel (14 μm). The distance between the lens and calibration target that is needed for a magnification of 21.42 is 1070 mm (for a 50 mm focal length lens). Thus, the calibration target, when placed 1070 mm from the 50 mm lens, will result in an image that maps each grating line onto every other pixel of the FPA. This will facilitate the formation of Moiré pattern that is the product of lens distortion variation and the properties of the calibration target.

The Moiré pattern irradiance, Iₘ(x, y), is the image that is captured by the camera-lens system (Step 3). It contains information about the radial lens distortion, as well as angular misalignments, magnification error, and the relative phase shift. The radial lens distortion is one of the mathematical quantities about which the present method provides quantitative information. Therefore the next step in ascertaining information about the distortion effects of a given lens is to mathematically model the resultant Moiré pattern (Step 3). By attributing the physical distortion effects incorporated in the Moiré pattern to corresponding terms in a distortion function D(x, y) it will be possible to localize the mathematical component responsible for the lens' contribution to the overall distortion function D(x, y). In general the distortion function D(x, y) is a component of the Moiré pattern irradiance Iₘ(x, y).

The resultant Moiré pattern can be described mathematically as the product of the focal plane array's spatial responsivity and the irradiance of the calibration target's image at the FPA. The exact spatial structure of the FPA's responsivity is not required to determine the Moiré pattern. It is only required that the responsivity have a periodic profile, with a period corresponding to P, one pixel width. The responsivity is modeled as

$$R ( x , y ) = \frac{1}{2} + \frac{1}{2} cos ( 2 π fx ) \qquad Eq . ( 1 )$$

where f=1/P.

The irradiance profile of the calibration target with period T can be described as

$$I ( {x}^{′} , {y}^{′} ) = {\sum }_{n = 0}^{∞} {a}_{n} cos ( π n [ {f}_{x}^{′} {x}^{′} + {f}_{y}^{′} {y}^{′} ] + φ ) \qquad Eq . ( 2 )$$

where f′ₓ=cos(2πθ)/T, f′_{y}=cos(2πθ)/T, and θ is the relative angular misalignment about the optical axis between the FPA and the calibration target. φ is a phase shift. The lens images the calibration target onto the FPA, resulting in an image plane irradiance of

$$I ( x , y ) = {\sum }_{n = 0}^{∞} {a}_{n} cos ( π nD ( x , y ) [ {f}_{x} x + {f}_{y} y ] + φ ) \qquad Eq . ( 3 )$$

where fₓ=cos(2πθ)/P, f_{y}=cos(2πθ)/P and D is given by

D(x, y)=M[1+k(x²+y²)+tₓx+t_{y}y]. Eq. (4)

D is the distortion function that results from distortion in the imaging lens and tilt errors of the calibration plate with respect to the x and y axes. The term k(x²+y²) is due to lens distortion, the terms tₓx and t_{y}y are due to the angular misaligmnents. M is a magnification factor.

Although, the total signal is given by I(x,y) multiplied by R(x,y), the only irradiance term that is passed by the modulation transfer function (MTF) of the system is the fundamental component (n=1 term in Eq. 3). Multiplying the fundamental component with R(x,y) results in the Moiré pattern. The Moiré pattern irradiance, aside from a multiplicative constant, is then described by:

Iₘ(x, y)=1+cos(πD└fₓx+f_{y}y┘+φ−[2πfx]). Eq. (5)

Ideally, one would like to eliminate all of the alignment terms experimentally, so that the Moiré pattern would only contain the radially lens distortion information. In practice, there will be residual alignment errors, so that the Moiré pattern will not be purely a function of radial lens distortion. However, the goal is to minimize all of the alignment terms as best as possible.

Referring to FIG. 10, a schematic block diagram illustrating the steps of a method to minimize lens distortion is shown. A calibration target and a lens of interest are provided (Step 1) and (Step 2) as has been previously discussed. A visible laser is used to perform the initial alignment (Step 3) of the FPA with the calibration target. The laser beam is directed onto the FPA without the lens being attached and reflected by the CCD array. The camera is rotated and tilted until the laser beam is directed back on itself. The lens of interest is then attached to the camera.

The calibration target is placed ˜1 meter from the camera lens, with the grating lines running parallel to the y-axis of the FPA. The camera lens is focused on the calibration plate, and the Moiré pattern observed (Step 4). The calibration target is then moved (Step 5) along the optical axis (while refocusing the lens) until the fringe spacing in the Moiré pattern is maximized. This procedure minimizes the M parameter in Eq. (4). This maximizes fringe spacing in order to minimize M.

The laser beam is then reflected off of the calibration target, and the calibration target is rotated about the x and y axes such that the laser beam reflects back on itself this realigns the target and FPA (Step 6). This procedure minimizes the angular misalignments parameters tₓ and t_{y} in Eq.(4).

The final alignment to be accomplished is the angular rotation of the calibration target about the optical axis (z-axis) (Step 7) so that the grating lines are aligned with the columns in the CCD array. This is accomplished by shimming one comer of the calibration target while observing the Moiré pattern When the fringes are disposed as close to vertical as possible, this alignment is minimized. Steps 1-7 as described in FIG. 10 and above, can be optionally iterated a few times to increase the probability that the alignment parameters are as close to their ideal values as possible.

Still referring to FIG. 10, illumination variations can be controlled (Step 8) for the image formed through the lens on the FPA. A monochromatic uniform background is placed behind the calibration target and back illuminated in various embodiments. In one illustrative embodiment, a white sheet is stretched behind the calibration target, and illuminated from the backside. This results in substantially uniform illumination across the target. An image of the calibration target is then recorded. The calibration target is then removed, and a background image of the monochromatic uniform background is recorded. The background image is normalized and subtracted from the target image. This has the effect of removing any illumination variations from the image. The target image can then be low-pass filtered, resulting in a Moiré pattern with fairly high contrast and uniformity in some embodiments.

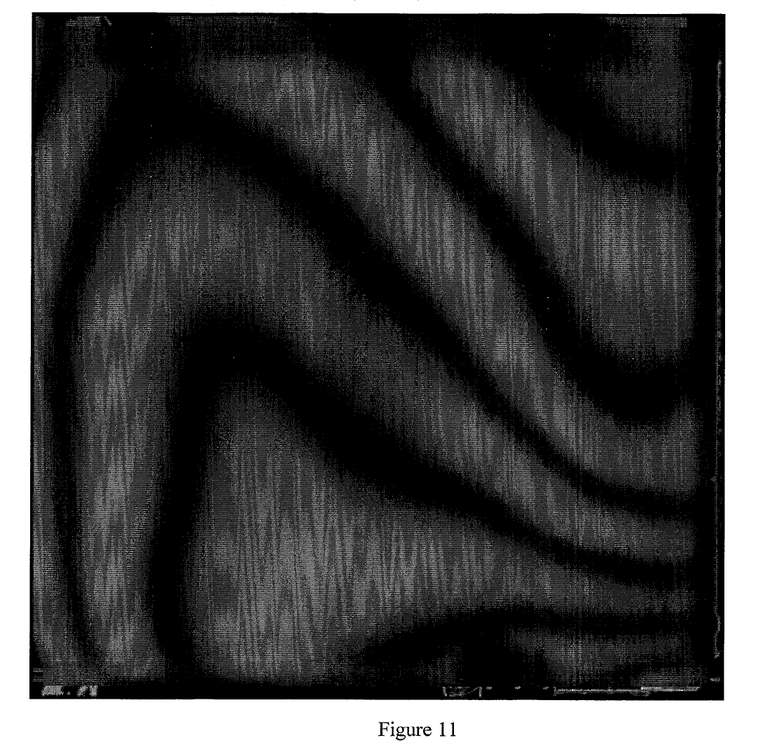

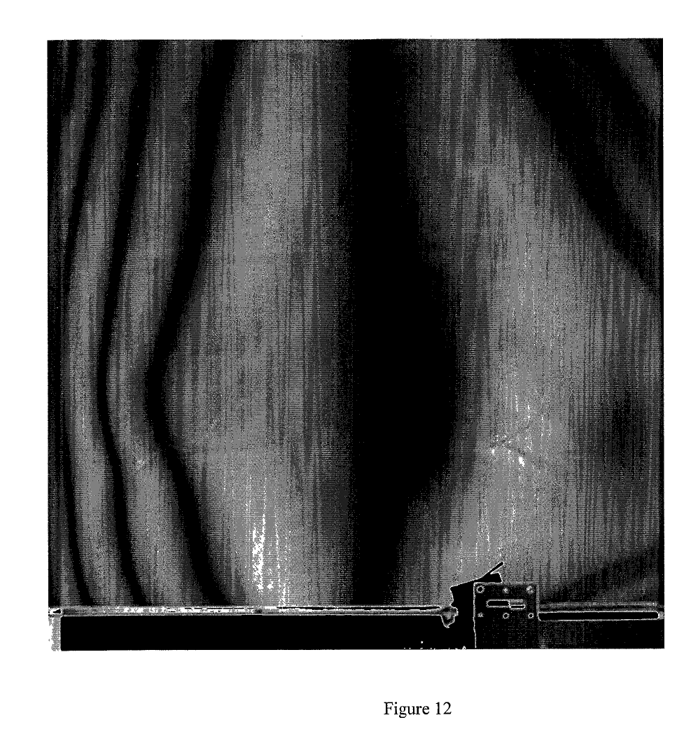

FIG. 11 shows a first measurement of the calibration target and FIG. 12 shows a subsequent second measurement of the calibration target which have had the illumination variations removed by the method discussed above. FIG. 11 and FIG. 12 are two different images of a calibration target that has been aligned using Steps 1-7 in FIG. 10. It is apparent from the vertical alignment of the fringes that the second measurement has a much smaller misalignment error in θ, the relative angular misalignment about the optical axis between the FPA and the calibration target.

The objective of the lens calibration is to determine the radial lens distortion coefficient, k. Measurements of the calibration target such as the two illustrative measurements in FIGS. 11 and 12 are taken after repeatedly cycling through Steps 1-8 in FIG. 10. The process of repeatedly imaging the calibration target while iteratively changing system parameters results in a set of best fit measurement images such as shown in FIG. 12. This experimental measurement and tuning of the calibration target image is done in concert with a simulation of the image created using the Moiré pattern irradiance function Iₘ(x, y). The various parameters used to generate the image from the function Iₘ(x, y). are changed, and the resulting image displayed. Initially parameters are set to zero, except for m, which is set to one. An optimization algorithm can be used to find the best fit between the measurements and Iₘ(x, y).

These images are compared to the measurement images, such as those in FIG. 11 and FIG. 12, with the goal of making the simulated and real images to be as close as possible. The table below contains the results of an optimization routine that makes the simulation images match as close as possible to the measurement images. This allows a mathematical model to be built from the parameters that fit Iₘ(x, y) to the lens of interest that is integrated into the larger imaging system.

TABLE 1
Simulation Parameters

| | First | Second |
|---|---|---|
| | Measurement | Measurement |
| k | .0036 | .0038 |
| M | .9955 | 1.004 |
| tₓ | .004 | −.004 |
| t_{y} | .006 | .003 |
| θ | −.06 | .003 |
| φ | 120 (deg.) | 90 (deg.) |

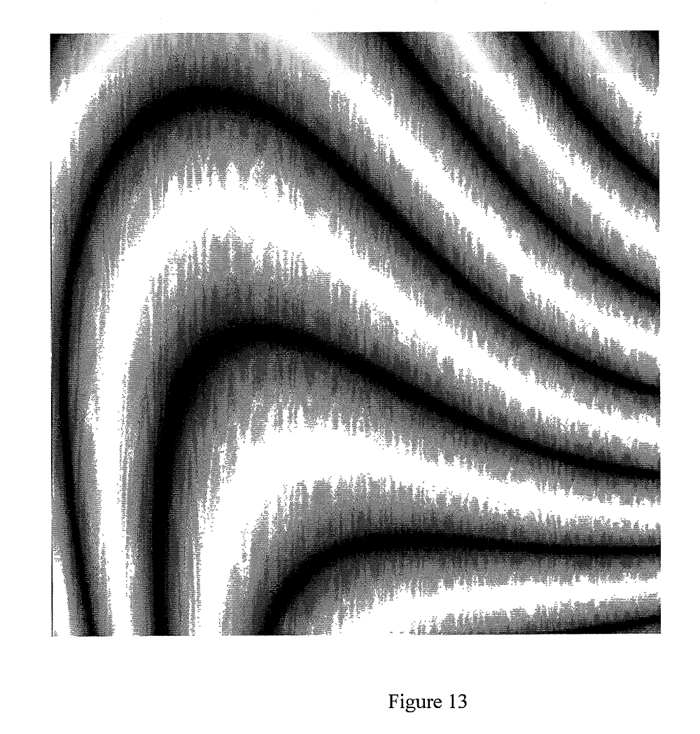

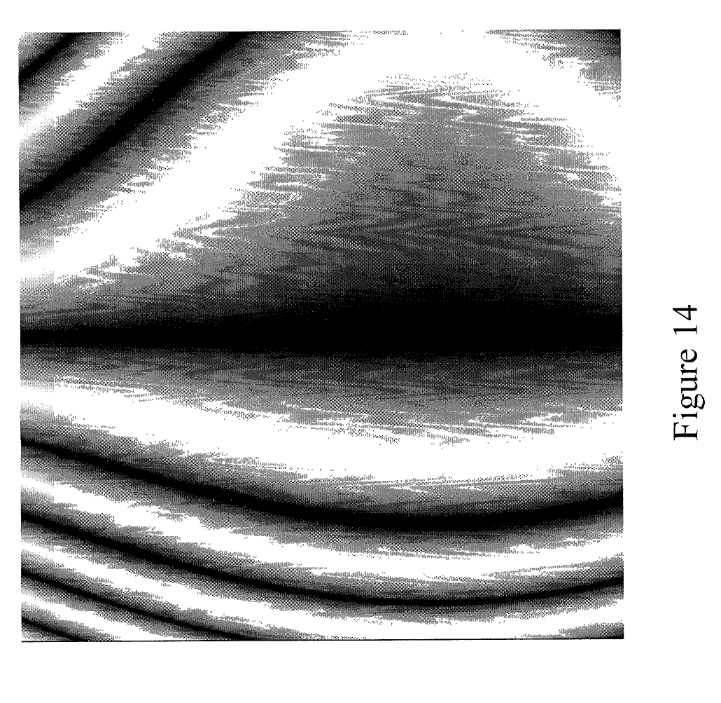

The parameters in Table 1 are used to produce simulated images (Step 9) when they are incorporated into Iₘ(x, y). The simulated image size is normalized on the computer running the model such that x and y range from −1 to 1. The array size used to produce the simulated results in the computer model is 500×500 pixels in one embodiment. FIG. 13 corresponds to the simulated image of the first measurement image in FIG. 11 and FIG. 14 corresponds to the simulated image of the second measurement image in FIG. 12.

The average k value, the radial lens distortion coefficient, of the two simulations is k=0.0037. Since the simulated parameters were determined by visually comparing the measured and simulated Moiré patterns, there is not a quantitative measure of the accuracy of k. By varying the parameters, and making numerous visual comparisons, the uncertainty in k is approximately +/−0.0004. The above k value represents the distortion coefficient for the 500×500 element pixel array used in the simulation. In order to match the 2048×2048 FPA that was used in the measurement, the k value has to be scaled by the factor (500/2048). This results in a new k value of k=0.0009+/−0.0001.

It is desirable to convert the k value into a distortion coefficient, q, that is described in terms of pixel number. For our 2048×2048 array, this is accomplished by setting:

$$q = \frac{k}{{( 1024 )}^{2}} = 8.6 \times {10}^{- 10}$$

The distorted pixel coordinates are now described by i′=(1+qrₚ²)i j′=(1+qrₚ²)j where rₚ=\sqrt{i²+j²}, and (i, j) are the undistorted pixel number. Thus by building a model from the real images in FIG. 11 and 12 and the simulated images in FIGS. 13 and 14, the lens aberration can be corrected (Step 10) by using these parameters to correct for errors in the pixel coordinates when measuring an object of interest.

Previously lens calibration has been viewed in the context of an optical receiver, such as a camera. Now the issue of lens calibration, as it relates to a projection lens in an interference fringe source will be explored in accordance with another aspect of the invention. AFI theory is based on the assumption that each of the two ‘point sources’ produces perfect spherical wavefronts. This is not the case, however, due to aberrations in the objective lens. The aberrations cause the resulting wavefronts to deviate from the ideal spherical shape. The light from the two aberrated point sources expands and overlaps, forming interference fringes. These interference fringes have the required sinusoidal profile; however the spatial locations of the fringes deviate from the ideal ‘point source’ fringe locations. Therefore a method for correcting the AFI theory based on perfect ‘point sources’ that compensates for the actual aberrated point sources is required.

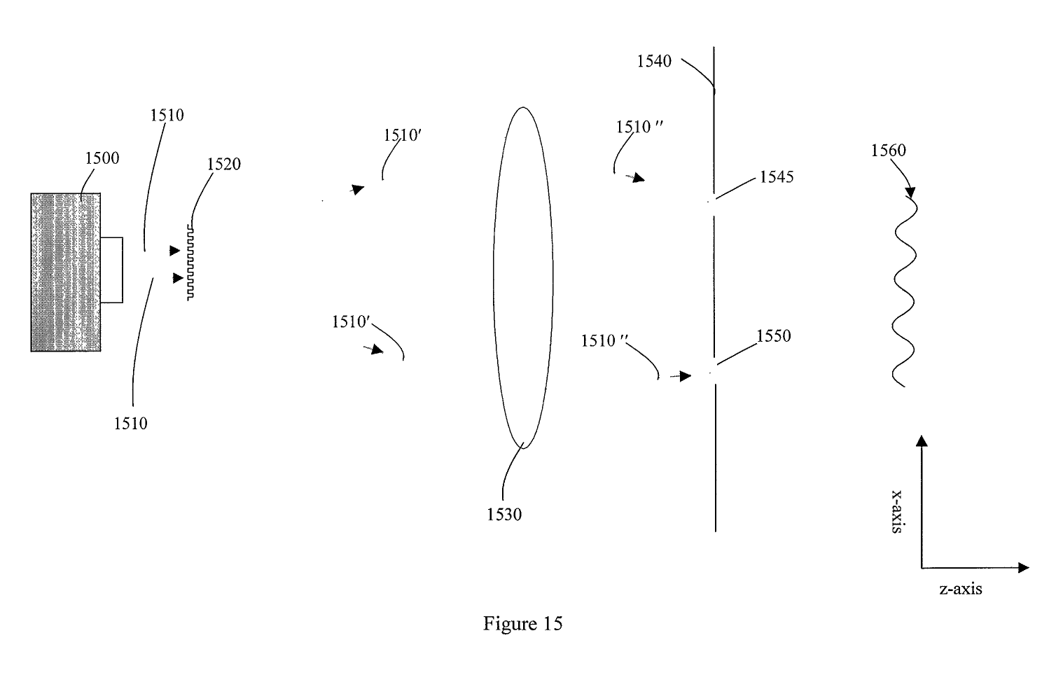

Referring to FIG. 15, an AFI system suitable for use with the invention is shown. This fringe projection based system, includes an expanded collimated laser source 1500 which emits a beam 1510 that passes through a binary phase grating 1520 in various embodiments. The light 1510′ diffracted from the phase grating 1520 is focused by an objective lens 1530 on to a spatial filter 1540. All of the various diffraction orders from the phase grating 1520 are focused into small spots at the plane of the spatial filter 1540. The spatial filter in one embodiment is a thin stainless steel disk that has two small holes 1545, 1550 placed at the locations where the +/−1^{st} diffraction orders are focused. The light 1510″ in the +/−1^{st} diffraction orders is transmitted through the holes 1545, 1550 in the spatial filter 1540 while all other orders are blocked. The +/−1^{st} order light passing through the two holes forms the two ‘point sources’ required for the AFI system. The light 1510″ expands from the two point sources and overlaps, forming interference fringes 1560 having sinusoidal spatial intensity.

A high aperture laser objective (HALO) sold by Linos Photonics (Linos Photonics Inc., Milford, Mass.) is a lens suitable for fringe projection in various preferred embodiments. The lens has a clear aperture of 15 mm and a focal length of 29.51 mm at a wavelength of 780 nm. The HALO lens is an air-spaced triplet that is designed to have near-diffraction limited performance on-axis. The optical design of the lens is made available by Linos Photonics, so that the aberrations that result from using the lens in interference fringe projection system can be modeled and accounted for during calibration and measurement.

The system configuration, including the HALO lens specifications was modeled using an optical design program. In one embodiment, the optical design program was Zemax (Focus Software, Inc., Tuscon, Ariz.) which includes lens design, physical optics, and non-sequential illumination/stray light features. Initially, the actual shape of the two wavefronts that emerge from the HALO lens must be determined. The lens design software will provide a wavefront result that will serve as a known value for calibration purposes. Light 1510 from the collimated laser diode 1500 impinges on the binary phase grating 1520. The binary phase grating has an aperture of 11.5×11.5 mm and a period of 55 μm in one embodiment. A variety of grating periods can be used, however only the finest fringe spacing, corresponding to the 55 μm period grating, needs to be calibrated

In one embodiment, the +/−1^{st} orders are diffracted from the grating at angles of +/−0.8 degrees. The lens design program, for example Zemax, is used to trace rays through the HALO lens at incident angles of +/−0.8 degrees. The lens design program calculates the difference between the actual wavefronts measured exiting the lens the and perfectly spherical wavefronts that would be present if the lens lacked any aberration. In general, the two point sources will not produce the same wavefront shape. However, in this case, because of the symmetry of the incident angles and the lens aberrations, the two wavefront shapes are the same. This wavefront shape is expressed as a polynomial that represents the phase error in light waves. The resulting error is a combination of astigmatism and spherical aberration and is given by

$${Φ}_{e} ( x , y ) = \frac{1}{2 π} [ {c}_{2} {y}^{2} + {c}_{3} {y}^{4} + {c}_{4} {x}^{4} + {c}_{5} {x}^{2} {y}^{2} ] \qquad Eq . ( 6 )$$

where the pupil dimensions in millimeters is (−5.75<x<5.75) and (−5.75<y<5.75). These pupil dimensions correspond to the 11.5×11.5 mm aperture of the binary phase grating. The numerical values for the coefficients of the polynomial expressing the phase error are

c₂=−0.028 c₃=0.0009 c₄=0.0009 c₅=0.0015 Eq. (7)

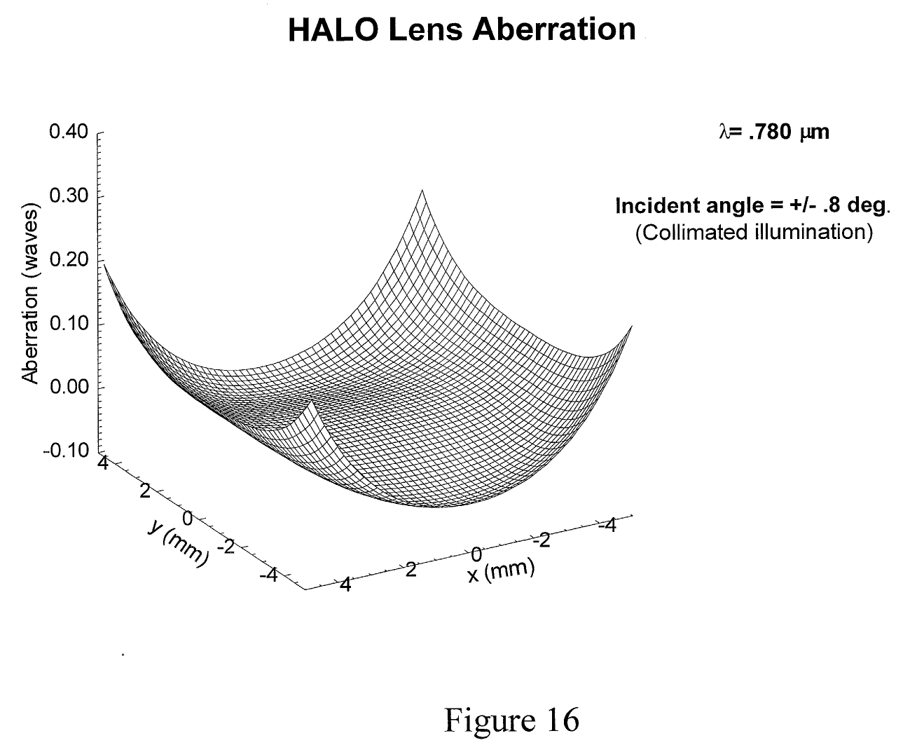

A graphical representation of the wavefront aberration is shown in FIG. 16 below. The curvature of the graph reveals the non-zero level of aberration in the fringe projection lens. The source aberrations in the projection lens cause the wavefronts to deviate from the spherical form that a “perfect” lens would generate. Non-spherical wavefronts will not undergo error free interference. Thus the lens aberrations leads to errors in the fringe number as a function of field angle with respect to the fringe source head.

The next step in the calibration process is to determine the effect of the wavefront errors on the resulting fringe locations. Eq. 6 describes the wavefront aberration for a point source centered at (x,y)=(0,0). In one AFI system embodiment suitable for use in the invention, the point sources are separated in the y-dimension by the distance ‘a’ where a=0.8368 millimeters. Therefore, the two wavefront errors, for the two different point sources, are given by

$$\begin{matrix}{Φ}_{1} ( x , y ) = \frac{1}{2 π} [ {c}_{2} {x}^{2} + {c}_{3} {x}^{4} + {{c}_{4} ( y - \frac{a}{2} )}^{4} + {c}_{5} {{x}^{2} ( y - \frac{a}{2} )}^{2} ] & Eq . ( 8 ) \\ {Φ}_{2} ( x , y ) = \frac{1}{2 π} [ {c}_{2} {x}^{2} + {c}_{3} {x}^{4} + {{c}_{4} ( y + \frac{a}{2} )}^{4} + {c}_{5} {{x}^{2} ( y + \frac{a}{2} )}^{2} ] & Eq . ( 9 )\end{matrix}$$

The resulting fringe phase error is then given by

$$ΔΦ = ( {Φ}_{1} - {Φ}_{2} ) = \frac{1}{2 π} \{ {c}_{5} {x}^{2} [ 2 ay ] + {c}_{4} [ 4 {ay}^{3} + {a}^{3} y ] \} \qquad Eq . ( 10 )$$

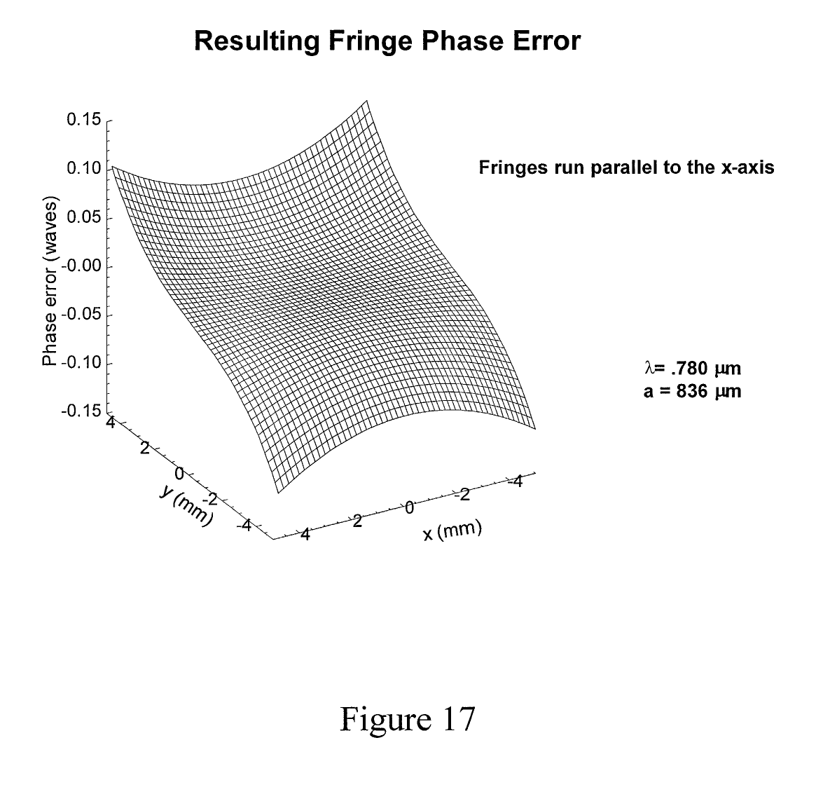

This fringe phase error is calculated over the pupil size of 11.5×11.5 mm is shown below. For small phase errors, such as those present in this embodiment, the phase error values will remain the same, independent of the projected pupil size. The resulting fringe phase error is illustrated in FIG. 17.

The fringe phase error has been analytically described as a function of the (x,y) coordinates over the pupil size/aperture size of the grating 1530. In order to develop a model for compensating for fringe error stemming from lens aberration, this fringe phase error must be converted into a correction factor. A closed form solution to determining the correction factor does not exist. Furthermore, the correction factor will be a function of the x,y, and z coordinates of the object. The additional z variable provides more unknown variables than known variables, which precludes a direct algebraic solution. Thus in order to find a correction factor; which can be used to compensate for lens aberration and the associated fringe errors, other mathematical techniques or simplifying assumptions must be employed.

In one embodiment, the correction factor can be obtained through an iterative approach. A measurement is performed with an AFI fringe source, such as the embodiment illustrated in FIG. 15, resulting in fringe number values, N, as a function of (i,j) locations where (i,j) are pixel number coordinates. This measurement involves projecting fringes on an object of interest such as a calibration standard 400. Using the ‘perfect point source’ algorithm, which is known to those of ordinary skill in the art (see U.S. Pat. No. 6,031,612) the x,y,z object coordinates can be calculated from the N and (ij) values that results when fringes are projected on the object of interest. The calculated x,y,z coordinates are then used to determine where in the projected pupil the object points were located. This provides an initial starting point as to where the object of interest is located in terms of the projected pupil. Knowing the object location in the projected pupil allows one to assign a fringe correction value to that location. This process can be repeated iteratively to get more accurate fringe correction values. When a suitable corrected fringe value has been determined based on the necessary number of iterations, the corrected N value can then be used in the ‘perfect point source’ algorithm to obtain a better estimate of the x,y,z object coordinates.

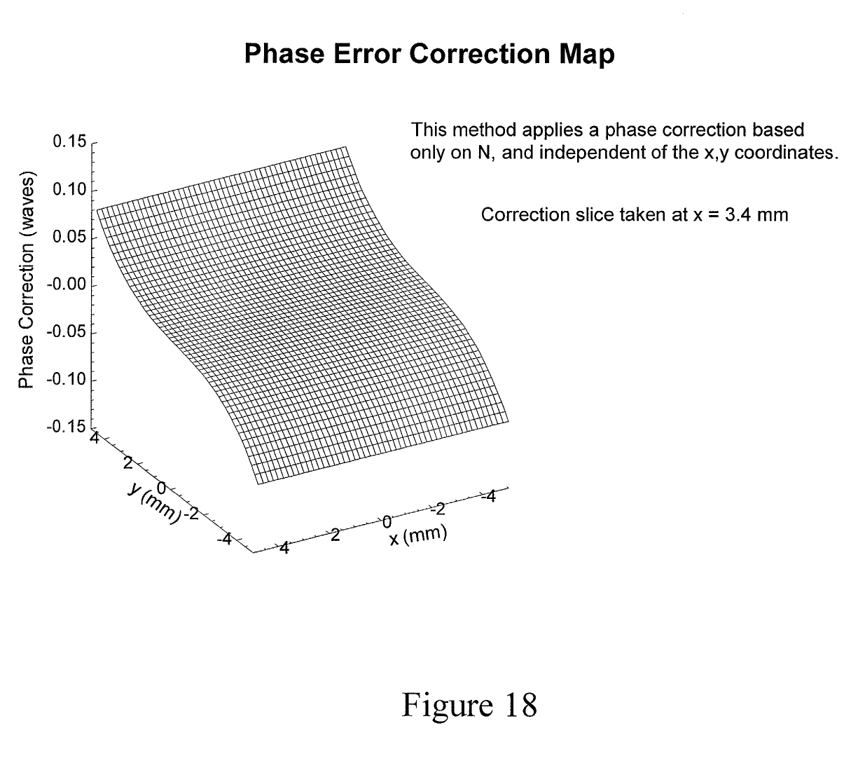

A simpler and faster approximation method is to apply a correction factor that is based solely on the measured N value, and independent of the actual object coordinates. In this scheme, a measurement is performed, resulting in the N values as a function of (i,j) locations. Knowing the N values, allows for the determination of the relative y coordinates in the pupil plane of the various points on the surface of a given object of interest. At this point there is no information regarding the relative x coordinates of the object points. Therefore one must construct an approximate phase correction map, based on the actual phase correction map that has no x dependence. This approximate phase error correction map is shown in FIG. 18. This correction map is simply a slice of a two dimensional curve extended in three dimensions. This represents one method of obtaining a result for the non-solvable phase error equation, Eq. (10).

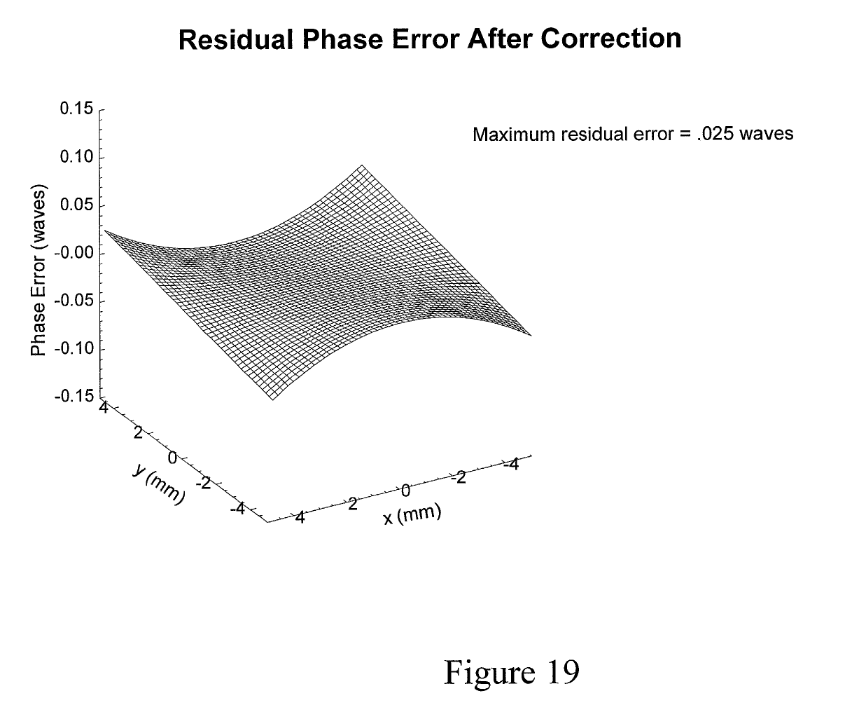

In one embodiment, the phase error correction map is constructed by first taking a y-slice of the phase error map at a fixed x-value. This is predicated on the assumption that phase errors will not change widely across different x-values. This is likely to be the case for projections lenses of a certain quality. This phase error slice is then replicated for all x-values across the pupil. Applying the approximate phase error correction map to the phase error map will result in some residual phase error. The amount of residual phase error will be a function of the x-value at which the y-slice is taken. The graph can be evaluated to take the y-slice at a minimum value. In this embodiment, the residual phase error is minimized when the y-slice is taken at an x pupil value of 3.4 mm. The residual phase error is shown below in FIG. 19. The maximum residual phase error, using this approximation method, is 0.025 waves.

The phase error correction map shown in FIG. 19 is a function of the y-coordinate in the pupil plane. In order to utilize the phase correction map in an AFI based measurement, the y-coordinate dependence is typically converted to a fringe number (N) dependence. By noting that the grating period is 55 μm, in this embodiment, and that each grating period produces two fringes, a conversion factor of 0.0275 mm/fringe is determined. It should be noted that the fringe spacing across the pupil plane is not exactly linear, so that the above conversion factor is an approximation. The reason that the fringes are not exactly linear is because the interference pattern between two perfect point sources does not produce perfectly linear fringes. However, the error that occurs with the linear approximation is small, and is negligible for this case. The above conversion factor is used to convert Eq.(10) from millimeter units to fringe number units. The resulting expression is

$${Δ}_{N} ( N ) = \frac{1}{2 π} \{ 2 {b}_{5} {ax}^{2} N + 4 {b}_{3} {aN}^{ 3} + {b}_{4} {a}^{3} N \} \qquad Eq . ( 11 )$$

where a=0.8368 and x=124. The b coefficients are: b₅=3.11×10⁻⁸, b₃=1.87×10⁻⁸, b₄=2.47×10⁻⁵. The corrected fringe number will be N′ where N′=N−Δ_{N}(N). N′, instead of N, will then be used in the N to Z algorithm. This process allows the aberrations in the projection lens of an AFI based imaging system to be compensated for when measuring a given object of interest.

In one embodiment, the AFI calibration method utilizes knowledge of the location of optical reference points on an optical calibration standard to determine various AFI calibration parameters that allow the i and j pixel coordinates and the fringe number N for a given pixel to be converted into a three-dimensional x, y, z location. This embodiment requires that the calibration standard be previously characterized to sufficient precision and accuracy. This characterization can be accomplished, for example, with a known calibrated 3D measurement device such as a CMM, laser tracker, photogrammetric camera, or AFI system. Alternatively, the standard can be manufactured to high tolerance in a well-known manufacturing process. This knowledge of the location of the optical reference points is generally referred to as the “truth data” of the calibration target.

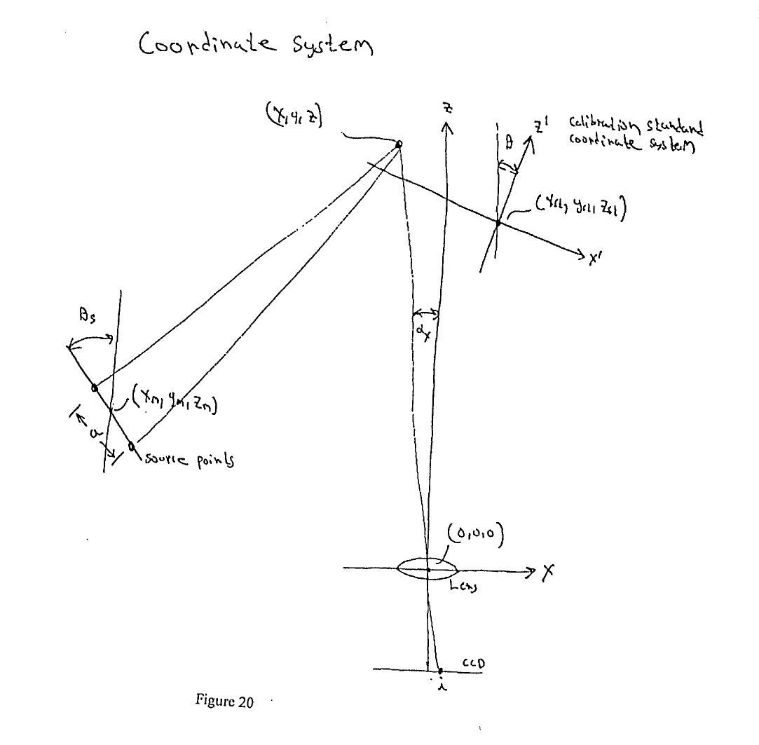

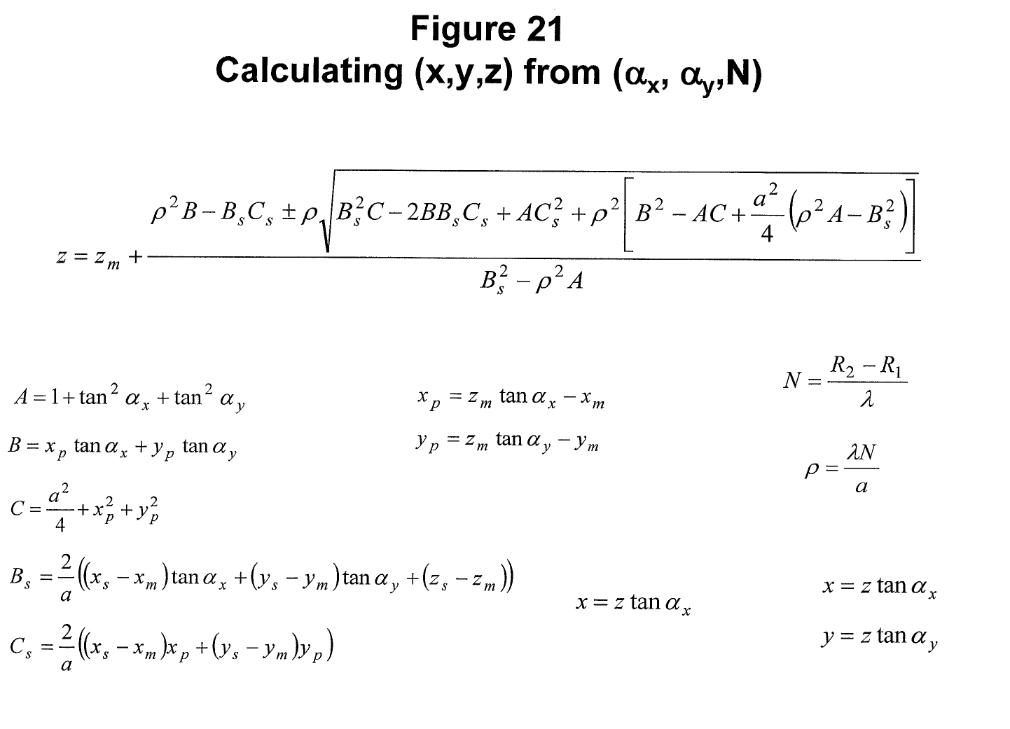

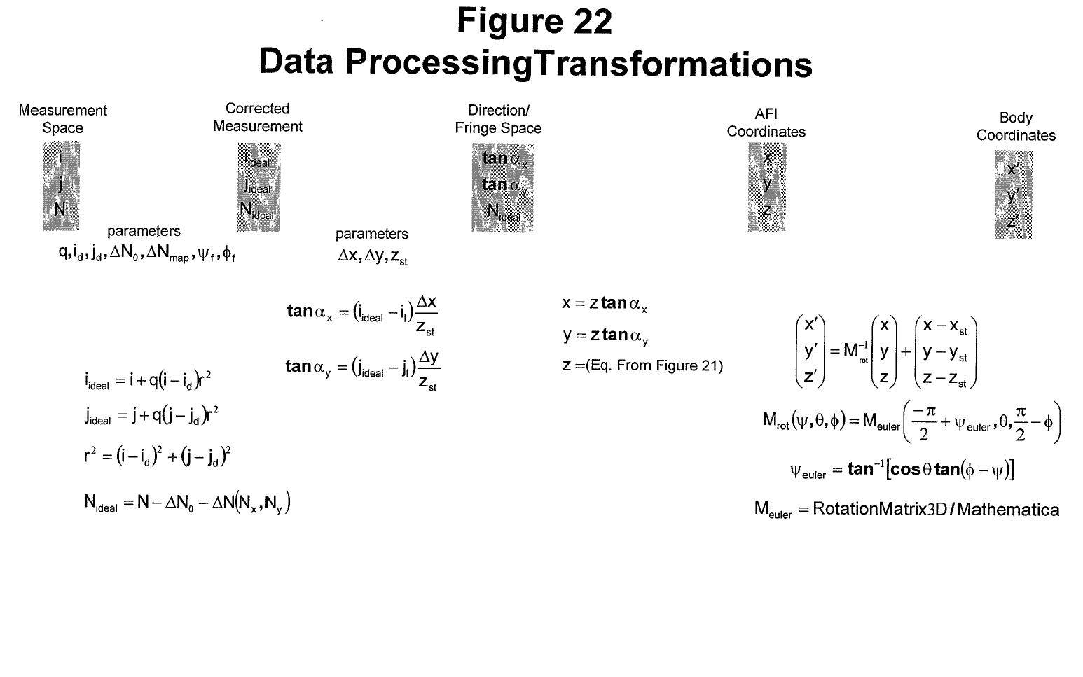

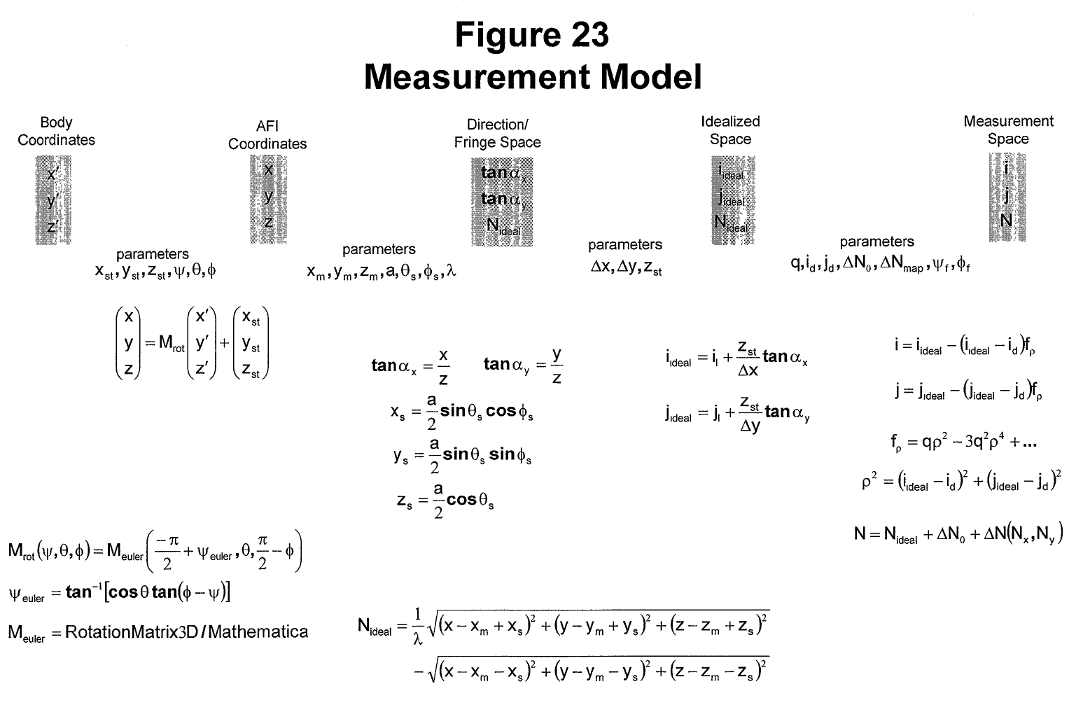

In the calibration process, the calibration standard, with known truth data, is measured by the AFI system being calibrated, and the location of the optical reference points is determined using initial estimates of the calibration parameters to convert i, j, and N into three-dimensional x, y, z coordinates. (Note that the calibration standard need only be measured once by the AFI system to produce the necessary “measurement data” for calibration.) To complete this conversion from i, j, N space to x, y, z, a measurement model, such as the one described in FIGS. 20 through 23 is required. FIG. 20 describes the measurement coordinate system. FIG. 21 contains the master equation that converts i, j, N values to x, y, z values. The pixel values i and j are assumed to have been corrected for lens aberrations and the fringe number N is assumed to have been corrected for fringe distortion when using the equation in FIG. 21. A generalized data transformation map from i, j and N space to x, y, z measurement coordinates is shown in FIG. 22. The reverse transformation is described in FIG. 23.

In one embodiment, the optimization algorithm compares the location of the optical reference points as represented by the truth data and by the measurement data to determine the system's current level of calibration. If the system is not calibrated to a sufficient level of accuracy and precision (likely for a first time set-up or after substantial environmental changes) the calibration algorithm adjusts system calibration parameters until the desired level of agreement between the truth and measurement data is achieved. Once the initial set of measurement data is acquired, all the subsequent calibration processing can be done without further data acquisition.

Two different measurements are required for producing the data from which the optical reference point locations are estimated in the calibration procedure. The first measurement is a standard AFI fringe measurement. The second measurement utilizes a ring-light source (or other suitable source) axially collocated with the camera lens. With fringe illumination absent, the ring-light illuminates the calibration standard, which is typically populated by retro-reflective calibration targets, and the camera acquires a single snapshot image.

The first step in processing the ring-light data is to identify and locate all the retro-reflective targets on the calibration standard that appear in the ring-light illuminated camera image. Once these targets are found, a centroiding algorithm finds the centroid of the pixel light-intensity of each retro-reflective target. This centroiding can be accomplished to sub-pixel accuracy and precision using standard algorithms known to those skilled in the art. (When using an active calibration standard, the ring light and the retro-reflective surfaces are not necessary because the active area of the calibration target emits light.)

The regular AFI fringe measurement is processed by fitting the N-fringe information over the surface of each individual retro-reflective target to a sufficiently complex polynomial surface in the pixel variables i and j. Normally a second-order polynomial in i and j is sufficient. A function representing this fit is generated, and this function is sampled at the sub-pixel centroid locations determined from the ring-light data. This smoothing and sampling process improves the quality of the measurement by minimizing the effects of noise. This procedure yields the i, j, N coordinates for each optical reference point. (For an active calibration target, it is not necessary to fit the N fringe information to a curve or to sample the N function at the centroid location. The fringe is measured directly at the detector location representing the optical reference point. The fringe number N can be determined by processing the intensity information at the detector as if this detector represented a pixel in the camera focal plane.)

The optimization algorithm makes use of specific aspects of these two kinds of calibration measurement data to calibrate the various AFI system components and determine their respective parameters. Typically, the N fringe data is used for fringe projector calibration, while the i and j information is used for camera calibration.

The fringe projector parameters that are optimized using the N fringe data are typically: (1) the fringe projector location, represented by the midpoint xₘ, yₘ, Zₘ between the two source points; (2) the fringe projector orientation, represented by the spherical polar angles θₛ and φₛ defining the direction of a line through the two source points; (3) the point-source spacing α, and (4) the source wavelength λ. Additionally, (5) the fringe projector distortion parameters can be estimated as part of the optimization. (This is an alternative approach to measuring the distortion directly as described previously.) In one embodiment, the fringe projector distortion is modeled as a 16-parameter polynomial function that represents fringe error as a function of fringe field coordinates.

The fringe-projector optimization algorithm begins by taking a best-estimate starting value for each of the above parameters and calculates the fringe error for each of the optical reference points. This fringe error is determined by taking the difference between the measured N values and the N values that are calculated from the x, y, z “truth” data using the measurement model and the estimated calibration parameters. An error in units of fringes is produced for each N centroid, and then a root-mean-squared total error is calculated. This RMS error is the figure of merit for the optimization algorithm.

Once the initial error is calculated from the starting values of the calibration parameters, the algorithm iterates through the parameter list, adjusting all parameters using standard minimization algorithms, that are known to those schooled in the art, until the global minimum is found and the N error is minimized. Typically, this error can be reduced to less than 0.05 fringes for a 0.5 m×0.5 m AFI field-of-view.

The next step in the calibration procedure is to determine the camera calibration parameters by minimizing the difference between i, j pixel locations of the optical reference points as determined from the centroid locations of the retroreflective targets (or active targets) and the locations predicted by the truth data, given the camera and lens distortion model. Typically, the camera calibration includes determination of (1) the camera magnification, represented by the distance Δx, and Δy corresponding to the projected pixel size at the intersection of the optical axis and the focal plane; and (2) lens distortion parameters, including, for example, the radial distortion parameter q, the pixel location i_{d}, j_{d} of the distortion center, the tangential distortion parameters qₜ₁, qₜ₂ and the thin-prism distortion parameters qₚᵣᵢ, qₚᵣⱼ. In addition, (3) the origin of the calibration standard, represented by xₛₜ, yₛₜ, Zₛₜ, and (4) the orientation of the calibration standard, represented by the angles θ, φ, and Ψ, are determined as a by-product of the calibration. The position and orientation of the calibration standard are expressed in the global x, y, z coordinate system, where the z axis is defined by the optical axis of the camera and the x and y axes are aligned with the pixel orientation. The angles θ and φ are the spherical polar angles representing the direction of the local z axis of the calibration standard. The angle Ψ represents the rotation misalignment of the calibration standard about the z axis.

The centroid information representing the location of the optical reference points that correspond to the calibration targets is ideal for calibrating camera lens distortion because this distortion is independent of the fringe projector and fringe distortion. Therefore, after camera calibration, the camera lens distortion parameters are typically considered fully determined and may be “frozen” throughout any remaining calibration steps. Note that lens distortion and magnification can be determined by any of a number of means. For example, it may be determined as described immediately above, or by the technique described previously using an amplitude transmission mask, or by any of a number of additional methods known to those skilled in the art.

The camera optimization algorithm again uses a best estimate starting value for each parameter. The starting estimate need only be approximate, and the previous calibrated value for each of these is generally adequate. The optimization algorithm calculates an error in pixel space between a projection of the truth measurement locations of each target centroid into the camera pixel coordinate system and the actual measured centroid location of each optical reference point. A pixel error is calculated for each individual centroid, and then the RMS total error is calculated. This RMS error is the figure of merit for the camera optimization. Again, a numerical optimization is performed with the goal of minimizing the i, j pixel error figure of merit. The iterations continue until convergence on the global minimum. Typically, this error can be reduced to below 0.05 pixels for a 0.5 m×0.5 m AFI system field-of-view.

These two optimizations alone are sufficient to calibrate all of the AFI system parameters. However, in one embodiment, another optimization can be performed to calibrate both the camera and the fringe projector parameters simultaneously. This is an optimization that occurs in the three-dimensional x, y, z measurement space. For the combined x, y, z optimization, the same parameters as in the fringe projector and camera optimizations are used. Typically, parameters associated with the camera lens distortion and the fringe projector lens distortion are not allowed to vary simultaneously in the x, y, z based optimization because these parameters can interact in a manner that can potentially cause them to deviate from their true values. However, they can be allowed to vary, one set at a time, in the x, y, z optimization in order to fine tune the previously calculated parameters.

This x, y, z, based optimization uses both the i, j centroids and N values to calculate the equivalent x, y, z three-dimensional locations of each optical reference point. It combines all the same information within the calibration algorithm as used in the main AFI measurement algorithm, and therefore, can provide an excellent total system calibration. The first step in this procedure is to correct for camera lens distortions and fringe distortions by applying the relevant distortion models to the measured data. Note that in order to achieve a substantially high level of accuracy and precision during calibration, a highly sophisticated camera distortion model may be required.

Once the i, j centroids have been corrected to account for camera distortions, they are transformed into the direction-space of the camera pixel array. Combining this information with the corrected N values allows the calculation of the x, y, z coordinates using the main i, j, N to x, y, z AFI algorithm described in FIG. 21. Finally, the x, y, z coordinates can be transformed into the truth measurement coordinate system to allow for an x, y, z component error calculation for each calibration target. This list of component errors can be used in an RMS calculation to determine the total error of the measurement. This error is the figure of merit for the x, y, z combined optimization algorithm. Once again, the optimization algorithm sequentially adjusts the parameters until the figure of merit has converged and a global minimum error is found. This error is typically on the order of 11 microns for a 0.5 m×0.5 m AFI system field of view, but the actual error may be lower because of uncertainty in the “truth” data.

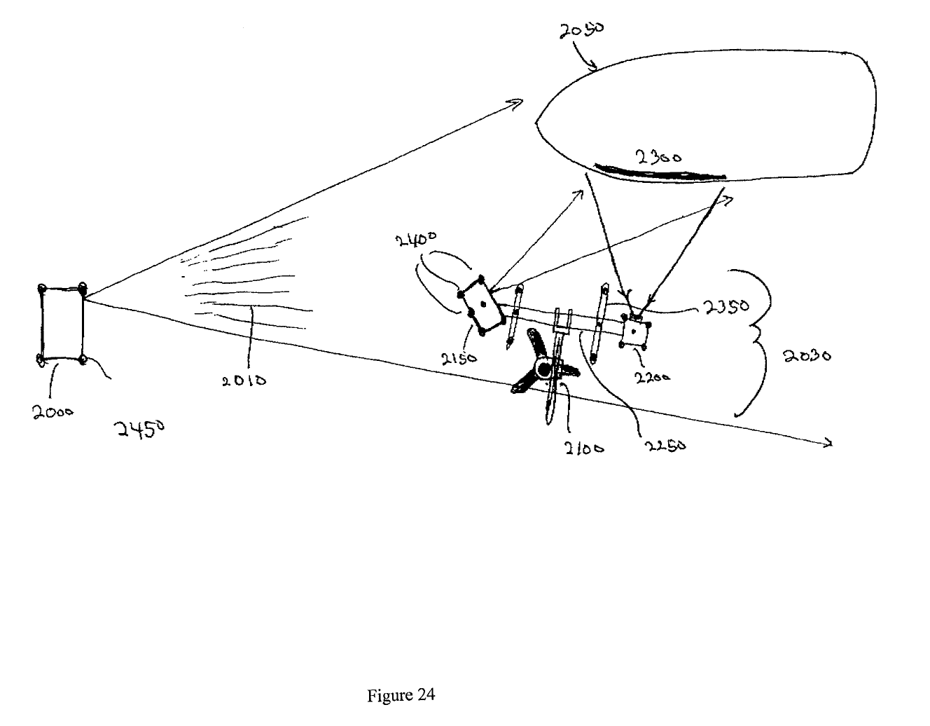

With reference to FIG. 24, an embodiment of the invention is described that makes it possible to accurately and quickly combine three-dimensional measurements of the surface of an object without relying on object features or markers on the object, whether these markers are passive or active targets or patterns projected onto the object. This invention also has the advantage that it does not require precise mechanical translations or rotations of the object or AFI system that are known to high accuracy.

In FIG. 24, AFI system 2030 is positioned to measure a surface area 2300 of object 2050. AFI system 2030 consists of a rigid structural element 2250 that maintains a fixed position and orientation between fringe projector 2150 and camera 2200. The structural element 2250 is attached to a stand or a positioning device 2100 that can be moved into different positions so that AFI system 2030 can measure all of the surface area of interest of object 2050 in different measurement patches.

Auxiliary AFI fringe projector 2000 projects a fringe pattern 2010 into a volume of space that illuminates AFI system 2030 for each of the measurement positions of the AFI fringe projector 2000 used for producing the measurement patches on object 2050, of which 2300 is an example. Optical reference points 2400 are attached to various locations on AFI system 2030. Appendages 2350, outfitted with optical reference points 2400, can be attached to the AFI system 2030 to provide an extended baseline in certain directions. In a preferred embodiment, the optical reference points 2400 are active and consist of small optical detectors or arrays of detectors that measure the fringe intensity of the fringes produced by fringe projector 2000 at various positions spread over the AFI system in three dimensions. The intensity values measured at these detector locations can be processed in the same manner as the pixel intensities in a standard AFI measurement of object 2050 to yield the fringe number N to very high precision. Thus the fringe projector 2000 is used to locate the position of the AFI system 2030 to a high degree of precision. The precision of these measurements is enhanced because the measurement is direct and highly localized and speckle effects are eliminated, even if the source used in fringe projector 2000 is a laser. The measurements are also not affected by depth of field so that the optical reference points can be widely separated for higher precision.

Thus, the set of optical reference points 2400 acts essentially as a calibration standard, provided that the location of these reference points is known relative to each other. The N values measured at these reference points can be compared with the N values predicted from knowledge of their physical location and the physical model for fringe number N described in FIG. 23. By comparing the measurements with the modeled values of N and minimizing the discrepancy in an optimization routine, the location of AFI system 2030 with respect to auxiliary fringe source 2000 can be determined to high precision. To enhance the precision further, additional fringe sources 2000 can be placed at additional locations. Furthermore, different fringe orientations can be used to take advantage of the fact that the measurements are more sensitive in directions that cut through the fringes. In one embodiment, fringe source 2000 can project fringes that are crossed with respect to one another for enhanced precision.

Measurements taken at different locations and orientations of AFI system 2030 are combined together by rotating and translating the groups of points obtained from each measurement into a preferred coordinate system. The transformation matrices for these rotations and translations are generated from knowledge of the changes in the location and orientation of AFI system 2030 between measurements, as determined by the measurement utilizing auxiliary fringe source 2000.

In a further embodiment, fringe source 2000 is outfitted with optical reference points 2450 and can be in the illumination volume of a separate fringe source that is not shown. This cross locating of source heads further increases the accuracy by which the relative positions and orientations of the individual components are known. Appendages 2350 containing optical reference points 2450 can also be attached to one or more of the fringe sources to improve measurement precision, but are not shown in the figure. In one embodiment, fringe sources also illuminate object 2050 and can be used to produce a multi-source AFI measurement as described in U.S. Pat. No. 6,031,612. One advantage of this arrangement is that triangulation can be performed based on the fringe values, for example, N₁, N₂, and N₃, making it is unnecessary to calibrate the camera or to know the relative position between the camera and the sources.

What is claimed is:

1. A calibration standard for a three-dimensional measurement system comprising:
a calibration standard structure; and
a plurality of optical targets, each of the optical targets being affixed to the calibration standard structure and defining a three-dimensional distribution of optical reference points.

2. The calibration standard of claim 1 wherein at least one of the optical targets comprises a passive calibration target.

3. The calibration standard of claim 1 wherein at least one of the optical targets comprises an active calibration target.

4. The calibration standard of claim 1 wherein at least one of the plurality of optical targets comprises an optical source and a diffusing target, and the optical source is configured to illuminate the respective diffusing target.

5. The calibration standard of claim 1 wherein the optical targets are removably affixed to the calibration standard surface.

6. The calibration standard of claim 1 wherein at least one of the optical targets further comprises an optical target surface, wherein the optical target surface comprises a retroreflective material.

7. The calibration standard of claim 1 further comprising a plurality of detectors adapted for measuring the local fringe intensity of a projected fringe pattern.

8. The calibration standard of claim 7 wherein at least one of the detectors is colocated with a respective one of the optical targets.

9. The calibration standard of claim 3 further comprising an active calibration target control system to independently activate and deactivate each of the plurality of active calibration targets.

10. The calibration standard of claim 1 wherein the calibration standard structure further comprises a contoured structure chosen to resemble a surface of an object of interest.

11. The calibration standard of claim 4 wherein the optical source is a light emitting diode.

12. The calibration standard of claim 1 further comprising a plurality of supports having a first end and a second end, the first end of each of the supports being affixed to the calibration standard structure, the second end of each of the supports being affixed to a calibration target surface.

13. The calibration standard of claim 1 wherein the plurality of optical targets comprise a plurality of pyramid targets, each of the pyramid targets having at least three diffuse sides and a vertex, the plurality of vertices being distributed in three dimensions.

14. The calibration standard of claim 1 further comprising a wireless module connected to at least one active calibration target.

15. An optical calibration target for use in a three-dimensional measurement system comprising:
a calibration target surface; and
an optical calibration target support attached to the calibration target surface.

16. The optical calibration target of claim 15 wherein the calibration target support further comprises an optical calibration target housing, wherein the optical calibration target housing comprises at least one of an optical source, and an optical detector, and a diffusing target.

17. The optical calibration target of claim 15 wherein the calibration target surface comprises a retroreflective coating.

18. The optical calibration target of claim 15 wherein the calibration target surface comprises an interference fringe intensity detector.

19. The optical calibration target of claim 15 wherein the target can be removably affixed to a geometric locus of interest on an object being measured by the three dimensional measurement system.

20. A calibration system for use in a three-dimensional measurement system comprising:
an optical receiver, an optical source, a calibration standard, and at least one optical calibration target wherein the optical source is disposed to illuminate the calibration standard, wherein the optical receiver is positioned to view at least one of the calibration standard and optical calibration target.

21. The system of claim 20 wherein the optical source has an annular structure adapted for mounting to an imaging system.

22. The system of claim 20 wherein the calibration standard comprises at least one fringe intensity detector.

23. The system of claim 20 wherein the calibration standard further comprises a calibration standard surface chosen to resemble a surface of an object of interest.

24. The system of claim 20 wherein the three-dimensional measurement system comprises an interference fringe projector.

25. A method for positioning an object at a focal point of an optical imaging device adapted for use in three-dimensional measurement system comprising the steps of:
providing a first movable orienting device fixed relative to the optical imaging device, wherein the first movable orienting device has a first projection element;
providing a second movable orienting device fixed relative to the optical imaging device wherein the second movable orienting device has a second projection element;
configuring the first and second movable orienting devices such that the first and second projection elements intersect at a focal point of the imaging device when the first and second movable orienting devices are moved in a prescribed manner; and
positioning the object at the focal point.

26. A device for positioning an object at a focal point of an optical imaging device adapted for use in three-dimensional measurement system comprising:
a first movable orienting device fixed relative to an optical imaging device wherein the first movable orienting device has a first projection element, and
a second movable orienting device fixed relative to the optical imaging device wherein the second movable orienting device has a second projection element; wherein
the first and second projection elements intersect at a focal point of the imaging device when the first and second movable orienting devices are moved in a prescribed manner.

27. The device of claim 26 wherein the first movable orienting device is a laser beam projector with a first laser beam projection element.

28. A method for calibrating a measurement system for determining three-dimensional information of an object, the method comprising the steps of:
acquiring two-dimensional fringe data representative of a calibration object, having three-dimensional truth data, using the measurement system;
determining three-dimensional coordinate data for the calibration object in response to the two-dimensional fringe data;
comparing the three-dimensional coordinate data and the three-dimensional truth data to generate a deviation measure; and
adjusting a calibration parameter if the deviation measure is greater than a predetermined value.

29. The method of claim 28 further comprising repeating the steps of acquiring, determining and comparing if the deviation measure is greater than the predetermined value.

30. The method of claim 28 wherein the calibration parameter comprises one of a source head relative position, a source head relative orientation, and a camera magnification.

31. The method of claim 28 wherein the calibration parameter comprises one of a projected fringe pattern lens distortion parameter and a camera lens distortion parameter.

32. The method of claim 28 comprising the additional step of changing at least one of an orientation or a position of the object by a specified amount.

33. The method of claim 28 wherein the deviation measure comprises a plurality of difference data.

34. The method of claim 28 wherein the deviation measure comprises a statistical measure.

35. The method of claim 28 wherein the three-dimensional coordinate data for the calibration object is determined at a plurality of locations on the object surface.

36. A depth of field independent method for calibrating a measurement system for determining three-dimensional surface information of an object, the method comprising the steps of:
providing a plurality of fringe detectors fixed in known spatial relationships;
providing at least one fringe source, which projects fringes
detecting the fringes at the plurality of fringe detectors to acquire a fringe data set; and
determining three-dimensional coordinate data for the spatial locations of the at least one fringe source.

37. A method of improving the fringe projection imaging of an object having a geometric locus comprising the steps of:
positioning at least one active calibration target at the geometric locus on the object; and
projecting fringes on the object.

38. The method of claim 37 further comprising the steps of:
detecting fringe projection data at the fringe intensity detector; and using the fringe projection data to extrapolate imaging data for the geometric locus.

39. The method of claim 37 wherein the geometric locus is a hole in the object.

40. The method of claim 37 wherein the geometric locus is an edge of the object.

41. A method for compensating for projection lens imperfections in a fringe projection system, the method comprising the steps of:
determining an ideal spherical wavefront output for a projection lens;
determining an actual wavefront output for the projection lens;
comparing the ideal spherical wavefront output with the actual wavefront output;
determining a first wavefront error for a first point source;
determining a second wavefront error for a second point source;
determining a fringe phase error from the first and second wavefront errors;
converting the fringe phase error into a correction factor; and
using the correction factor to compensate for projection lens imperfections.

42. A method for compensating for lens imperfections in a fringe projection system, the method comprising the steps of:
(a) projecting a fringe on a fringe detector;
(b) measuring a fringe intensity;
(c) measuring a first pixel coordinate (i) and a second pixel coordinate (j);
(d) determining a three dimensional coordinate from the given fringe intensity, first pixel coordinate, and the second pixel coordinate;
(e) determining a correction factor to determine a correction fringe intensity; and
(f) determining a corrected three dimensional coordinate based on the correction fringe intensity.

43. A method for compensating for lens imperfections in a fringe projection system, the method comprising the steps of
(a) projecting a fringe on a fringe detector;
(b) measuring a fringe number, wherein N is the fringe number;
(c) measuring a first pixel coordinate (i) and a second pixel coordinate (j);
(d) determining a relative coordinate in a pupil plane from corresponding fringe number;
(e) constructing an approximate phase correction map from the relative coordinates;
(f) determining a correction fringe number; and
(g) determining a corrected three dimensional coordinate based on the correction fringe number.

44. A method for compensating for distortion in an optical imaging system, the method comprising the steps of:
providing a calibration target comprising optical grating lines; providing an optical imaging system comprising a focal plane array, and a plurality of system parameters, wherein the focal plane array further comprises pixels;
aligning the optical grating lines of the calibration target with the pixels;
imaging a calibration target on a focal plane array of an optical imaging system;
adjusting system parameters based on an iterative process to generate a data set;
simulating a Moiré pattern from the data set and an image of the calibration target; and
generating distortion coefficients to compensate for distortion in the optical imaging system from the simulated Moiré pattern.

45. A method for compensating for distortion in an imaging optical system, the method comprising the steps of:
(a) designating a first distortion free pixel coordinate (i), a second distortion free pixel coordinate (j), and a distortion free radius in a sensing array;
(b) designating a distortion center comprising a first distortion coordinate, a second distortion coordinate, and a distortion radius in a sensing array; and
(c) designating a distortion parameter relating the distortion free radius and the distortion radius.

46. The method of claim 45 further comprising the steps of
imaging a calibration target to establish the distortion parameter; and
minimizing the distortion parameter.

47. The method of claim 45 further comprising the steps of
imaging a calibration target to establish the distortion parameter; and
using the distortion parameter to minimize a distortion error in an imaging measurement.

48. A method for appending a plurality of related three-dimensional images of an object, each of the three-dimensional images having a unique orientation with respect to a three-dimensional measurement system, the method comprising the steps of:
projecting an orientation pattern at a fixed position on the object;
acquiring a first three-dimensional measurement of the object, the three-dimensional measurement system being at a first position relative to the object;
moving the three-dimensional measurement system to a second position relative to the object;
acquiring a second three-dimensional measurement of the object, the orientation pattern being at the fixed position on the object and the three-dimensional measurement system being at a second position relative to the object.

49. The method of claim 48 wherein the orientation pattern comprises a plurality of laser spots.

50. The method of claim 48 wherein the orientation pattern comprises a projected optical pattern.
